(19) United States
(12) Patent Application Publication
(10) Pub. No.: US 2024/0416502 A1
(43) Pub. Date: Dec. 19, 2024

(54) Apparatuses and methods for and with mobile platforms for the transport of cargo goods

(71) Applicant: Fraunhofer-Gesellschaft zur Förderung der angewandten Forschung e.V., München (DE)

(72) Inventors: Patrick KLOKOWSKI, Dortmund (DE); Mathias ROTGERI, Dortmund (DE); Jan Sören EMMERICH, Dortmund (DE); Michael TEN HOMPEL, Dortmund (DE); Sören KERNER, Dortmund (DE)

(21) Appl. No.: 18/813,196

(22) Filed: Aug. 23, 2024

Related U.S. Application Data
(63) Continuation of application No. PCT/EP2023/054805, filed on Feb. 27, 2023.

(30) Foreign Application Priority Data
Feb. 28, 2022 (DE) 102022202045.6

(51) Int. Cl. B25J 5/00; B25J 9/16; B25J 15/00; B25J 15/02

(52) U.S. Cl. CPC B25J 5/007; B25J 9/162; B25J 15/0004; B25J 15/0253

(57) ABSTRACT

Embodiments according to a first aspect of the present invention include an apparatus for transporting cargo, wherein the apparatus includes a mobile platform formed as an inverted pendulum and pick-up means arranged on the mobile platform. The apparatus is configured to lift the cargo by means of the pick-up means and to transport the lifted cargo.

### CROSS-REFERENCE TO RELATED APPLICATIONS

This application is a continuation of copending International Application No. PCT/EP2023/054805, filed Feb. 27, 2023, which is incorporated herein by reference in its entirety, and additionally claims priority from German Application No. 102022202045.6, filed Feb. 28, 2022, which is also incorporated herein by reference in its entirety.

Embodiments according to the present invention include apparatuses and methods for and comprising mobile platforms for the transport of cargo goods. The present invention further relates to apparatuses and methods for picking up, putting down and transporting cargo goods.

Further embodiments according to the present invention include apparatuses and methods with mobile platforms for cargo goods and/or for adapting a wheel contact area.

Further embodiments according to the present invention include apparatuses for transporting cargo with mobile platforms configured as an inverted pendulum.

Further embodiments according to the present invention include apparatuses for transporting cargo with pick-up means arranged on a mobile platform, which comprises at least two arms.

Further embodiments according to the present invention include apparatuses for transporting cargo with control means for providing a balancing movement.

Further embodiments according to the present invention include apparatuses for transporting cargo with support structures and operating modes, wherein the support structures can be in contact with ground or can be raised from the ground.

Further embodiments according to the present invention include apparatuses with control means for adapting a size of the contact area of the wheel of a mobile platform.

### BACKGROUND OF THE INVENTION

Inexpensive automated vehicles for transporting loads/load carriers are being used more and more frequently (market trend towards automation using automated guided vehicles, especially at low cost). Up to now, load transfer has mostly been configured for interaction with conveyor technology/workstations. So far, there are no simple/cheap solutions available on the market for putting down/picking up cargo goods to/from a floor (especially without aids). In particular, however, there is no solution available on the market that combines putting down/picking up cargo goods to or from a floor and to or from other heights (e.g. onto a table or into a shelf). In summary, there has been a problem to date in providing a pick-up of cargo goods from the floor and other heights by means of automatic vehicles using actuators that are inexpensive overall. Another problem is that cargo goods (e.g. bulk goods, liquid goods) cannot be subjected to high accelerations without simultaneous balancing of the moving masses (e.g. by tilting the container), as the same could otherwise be lost or spilled.

### Conventional Technology

Transfer means of transport systems for containers etc. as described above are rarely completely without infrastructure. The “Stack Access Machine” (Fraunhofer IML), for example, can pick up containers, but cannot be used cost-effectively for the transport of individual containers. The relatively inexpensive automated guided transport vehicles available on the market, Leo Locative (BITO Lagertechnik) and Weasel (SSI Schäfer), can transport smaller loads cost-effectively, but can only hand them over at special transfer stations. It is not possible to pick up/put down loads from/to any location on the floor. “FLIP” (Fraunhofer IML) can pick up containers (and small stacks of containers) from the floor, transport them and put them down again. LoadRunner (Fraunhofer IML) can transport and sort cargo goods at high speed. However, loads cannot be picked up without aids and loads can only be put down passively. Special robots for shelf loading (e.g. Magazino Soto) are known, but are mechanically complex.

General solutions for lifting realized by means of vehicles (if it is not possible to drive underneath) include, for example, separate lifting drives and the use of belts, ropes, spindles and possibly linear guides. This means that such solutions are also associated with a large amount of hardware, for example. Spillable cargo goods are either transported slowly or in closed containers, which can lead to slow transport speeds or higher storage effort (e.g. a need for special containers).

### SUMMARY

According to an embodiment, an apparatus for transporting cargo may have: a mobile platform formed as an inverted pendulum; and pick-up means arranged on the mobile platform; wherein the apparatus is configured to lift the cargo by means of the pick-up means and to transport the lifted cargo.

According to another embodiment, an apparatus for transporting cargo may have: a mobile platform; and pick-up means arranged on the mobile platform, which comprises at least two arms and is configured to lift the cargo using the two arms by picking up the cargo between the two arms.

According to another embodiment, an apparatus for transporting cargo may have: a mobile platform; and pick-up means movably arranged on the mobile platform, configured to lift the cargo comprising the transport means and cargo arranged in the transport means; and control means; wherein the apparatus is configured to move the cargo with one movement; and wherein the control means is configured to keep an acceleration force of the cargo, acting under the influence of the movement, relative to the transport means within a tolerance range in a predefined orientation during the movement of the cargo by providing a balancing movement.

According to another embodiment, an apparatus for transporting cargo may have: a mobile platform, the mobile platform comprising a set of wheels on an axis for movement on a ground; and pick-up means arranged on the mobile platform, wherein a support structure for contact with the ground is arranged on the pick-up means; and control means configured to control the pick-up means to lift the cargo, starting from a first operating mode in which the set of wheels and the support structure are in contact with the ground, and to switch to a second operating mode in which the support structure is lifted from the ground; or is arranged along an axis of wheels from which the support structure is positioned away in the first operating mode.

According to another embodiment, an apparatus may have: a mobile platform, the mobile platform comprising a set of wheels for movement on a ground; and an actuator system connected to the set of wheels for adapting a size of a contact area of a wheel of the set of wheels with the ground; and control means for controlling the actuator system, wherein the control means is configured to change the size of the contact area of the wheel by means of the actuator system in dependence on a driving speed of the apparatus, a change of a direction vector of the apparatus, of properties of the ground, or in dependence on a ground condition.

According to another embodiment, a method for transporting cargo may have the steps of: lifting the cargo by means of pick-up means, wherein the pick-up means is arranged on a mobile platform and wherein the mobile platform is configured as an inverted pendulum; and transporting the lifted cargo.

According to another embodiment, a method for transporting cargo may have the steps of: picking up the cargo between at least two arms of a pick-up means, wherein the pick-up means is arranged on a mobile platform; and lifting the cargo using the two arms.

According to another embodiment, a method for transporting cargo may have the steps of: lifting the cargo by means of pick-up means movably arranged on a mobile platform, wherein the cargo comprises transport means and cargo arranged in the transport means; and moving the cargo with one movement; and providing a balancing movement, by means of control means, during the movement of the cargo, in order to keep an acceleration force of the cargo, acting under the influence of the movement, relative to the transport means within a tolerance range in a predefined orientation.

According to another embodiment, a method for transporting cargo may have the steps of: controlling pick-up means for lifting the cargo, starting from a first operating mode in which a set of wheels and a support structure are in contact with a ground, to switch to a second operating mode in which the support structure is lifted from the ground; wherein the pick-up means is arranged on a mobile platform and wherein the support structure for contact with the ground is arranged on the pick-up means; and wherein the mobile platform comprises the set of wheels on one axis for movement on a ground.

According to another embodiment, a method for transporting cargo may have the steps of: controlling an actuator system by means of control means to change the size of a contact area of a wheel of a set of wheels by means of the actuator system in dependence on a driving speed of a mobile platform, a change of a direction vector of the mobile platform or in dependence on a ground condition, wherein the mobile platform comprises the set of wheels for movement on the ground; and wherein the actuator system for adapting the size of the contact area of the wheel of the set of wheels with the ground is connected to the set of wheels.

In the following, embodiments according to the present invention are presented in a structured manner on the basis of inventive aspects. However, it should be noted that this classification is merely for a better understanding of the invention and that the inventive aspects can be used in any combination. Accordingly, for example, an embodiment according to one of the aspects two, three, four or five can be supplemented by features, details or functionalities of embodiments according to the first aspect, individually or in combination.

One finding of the present disclosure is that the vehicle dynamics of a platform configured as an inverted pendulum comprises synergetic advantages with regard to picking up cargo goods by means of pick-up means arranged on the mobile platform and vehicle complexity.

Embodiments according to a first aspect of the present invention include an apparatus for transporting cargo, wherein the apparatus includes a mobile platform formed as an inverted pendulum and pick-up means arranged on the mobile platform. The apparatus is configured to lift the cargo by means of the pick-up means and to transport the lifted cargo.

A mobile platform in the form of an inverted pendulum can be configured with few moving parts and can therefore be provided with low complexity, low wear and low costs. At the same time, however, highly dynamic driving maneuvers are possible by tilting the mobile platform with the pick-up means, for example in a simple model of the optionally actuated “pendulum rod” of the inverted pendulum.

In particular, cargo can be picked up and/or put down independently from a number of different heights using the pendulum dynamics. The pick-up means can be configured, for example, by means of one or several arms and can comprise a plurality of possible contact elements for contacting the cargo. For example, when using a single arm, a magnetic contact can be established or a contact element can be hooked into the cargo. For example, when using several arms, the cargo can be gripped or clamped laterally by means of several contact areas. For example, a frictional and/or positive connection can be established.

According to further embodiments according to the first aspect of the present invention, the apparatus is configured to comprise contact areas for forming a contact with a ground. Further, the apparatus is configured to provide the contact along exactly one axis of contact areas at least during a transport trip for transporting the cargo. The inventors have recognized that the use of exactly one axis of contact areas enables balancing according to an inverted pendulum on the axis and thus a highly dynamic driving mode.

According to further embodiments according to the first aspect of the present invention, the platform comprises two leg elements arranged substantially parallel to each other and spaced apart from each other in a floor region. Further, the apparatus is configured to position the cargo at least temporarily between the leg elements. The inventors have recognized that this allows picking up cargo goods even from the ground on which the vehicle is driven.

According to further embodiments according to the first aspect of the present invention, the apparatus comprises a chassis with a set of wheels, wherein a first subset of the set of wheels is arranged on a first leg element and wherein a second subset of the set of wheels, which is disjoint to the first subset, is arranged on a second leg element, which is different from the first leg element. The inventors have recognized that good driving dynamics can be achieved by comprising two disjoint subsets of wheels on the two leg elements.

According to further embodiments according to the first aspect of the present invention, the apparatus comprises control means configured to balance the apparatus and the cargo using additional information, wherein the additional information comprises at least one of loading condition of the apparatus, a speed of the apparatus, an acceleration of the apparatus, an inclination of the mobile platform, an orientation of the pick-up means relative to the mobile platform, a relative movement of the pick-up means relative to the mobile platform, a relative movement of the cargo with respect to the mobile platform, a weight of the cargo, a center of gravity of the cargo, a torque in an actuator of the apparatus, information about the geometry of the cargo and/or information about the type of cargo. The inventors have recognized that the additional information can be used to regulate and/or control the vehicle dynamics in a particularly robust manner.

According to further embodiments according to the first aspect of the present invention, the apparatus comprises sensor means configured to detect the additional information and to provide a sensor signal based thereon. Further, the control means is configured to balance the apparatus and/or the apparatus and the lifted load based on the sensor signal. The inventors have recognized that by means of the sensor means, the apparatus itself can provide real-time data for regulating and/or controlling the vehicle dynamics.

According to further embodiments according to the first aspect of the present invention, the pick-up means provides at least one further pendulum segment. The inventors have recognized that this can improve a range or agility of picking up cargo or putting down cargo.

According to further embodiments according to the first aspect of the present invention, the apparatus comprises a platform height relative to a traversed ground during a transport trip for transporting the cargo, and the apparatus is configured to raise the cargo to a height above the platform height during the transport trip. The inventors have recognized that a stable and dynamically controllable common center of gravity of apparatus and cargo can be balanced in that way.

According to further embodiments according to the first aspect of the present invention, the apparatus is configured to align the mobile platform relative to a surface normal of a traversed ground along a first direction and along a driving direction or in the opposite direction thereto. Further, the apparatus is configured to align the pick-up means relative to the surface normal opposite to the first direction. The inventors have recognized that a particularly stable driving mode can be achieved in that way.

According to further embodiments according to the first aspect of the present invention, the pick-up means comprises at least two arms and is configured to lift the cargo using the two arms by picking up the cargo between the two arms. The inventors have recognized that cargo goods can be lifted by means of form and/or force fit, for example without or with only very low requirements for a special configuration of the cargo, so that a plurality of different cargo goods can be lifted with the apparatus.

According to further embodiments according to the first aspect of the present invention, the apparatus comprises control means, wherein the control means is configured to control a first arm and a second arm of the at least two arms independently of each other, and/or wherein the control means is configured to control the first arm and the second arm in dependence on each other. The inventors have recognized that a common control can keep the complexity of the apparatus low. Further, the inventors have recognized that asymmetrical cargo goods and/or cargo goods with uneven weight distribution can be lifted better by means of individual control of the arms.

According to further embodiments according to the first aspect of the present invention, at least one of the at least two arms comprises a contact element, wherein the contact element comprises an elastic, in particular a viscoelastic material; and wherein the contact element is configured to establish contact with the cargo and thereby adapt to a shape of the cargo in order to lift the cargo under the action of the elastic material. The inventors have recognized that a particularly stable contact can thus be established between pick-up means and cargo.

According to further embodiments according to the first aspect of the present invention, the pick-up means comprises exactly two arms. The inventors have recognized that the use of only two arms can provide a good trade-off between hardware complexity and cargo pick-up stability.

According to further embodiments according to the first aspect of the present invention, the at least two arms comprise one contact element each, wherein the contact elements are configured to establish a frictional fit and/or a force fit and/or a form fit with the cargo.

According to further embodiments according to the first aspect of the present invention, the pick-up means is configured to pick-up the cargo between a first contact element for contacting the cargo and a second contact element for contacting the cargo. The first contact element and the second contact element are connected to actuator means and are rotatably mounted, and the apparatus is configured to control the actuator means during pick-up and/or during acceleration of the cargo, to rotate the first contact element and the second contact element in order to adjust an orientation of the cargo. The inventors have recognized that even spillable cargo can be safely lifted and moved in that way.

According to further embodiments according to the first aspect of the present invention, the pick-up means comprises bellows, wherein the bellows is configured to release the cargo in a first state and to adapt to a shape of the cargo in a second state to provide a form fit and/or a force fit with the cargo to lift the cargo. The inventors have recognized that a plurality of cargo goods can be lifted and transported in that way, for example independently or approximately independently of an external shape of the cargo goods.

According to further embodiments according to the first aspect of the present invention, the bellows is a pneumatic bellows. The inventors have recognized that pneumatic bellows enable simple actuation by means of compressed air and thus hardware expenses can be kept to a minimum.

According to further embodiments according to the first aspect of the present invention, the pick-up means comprises two opposite contact elements and the contact elements are configured to pick up the cargo between the contact elements. Further, the pick-up means comprises actuator means coupled to the contact elements and arranged to move the two contact elements towards each other. The inventors have recognized that cargo can be securely clamped between the contact elements in that way.

According to further embodiments according to the first aspect of the present invention, at least one contact element is coupled to the actuator means via lever means, and the actuator means is configured to move the at least one contact element towards the opposite contact element by means of the lever means. The inventors have recognized that a delivery movement can thus be provided with few moving components.

According to further embodiments according to the first aspect of the present invention, the two contact elements are coupled to the actuator means via respective lever means, and the one actuator means is configured to move the two contact elements towards each other by means of the respective lever means. The inventors have recognized that a large delivery movement can thus be provided with little hardware effort.

According to further embodiments according to the first aspect of the present invention, the actuator means comprises a linear actuator. Linear actuators can be particularly robust and cost-effective.

According to further embodiments according to the first aspect of the present invention, the pick-up means comprises two opposite contact elements configured to pick up the cargo by means of contacting the cargo, wherein at least one of the contact elements is configured to be moved in the direction of the cargo by means of an eccentric. The inventors have recognized that a delivery movement can be provided with low hardware complexity by means of an eccentric.

According to further embodiments according to the first aspect of the present invention, the pick-up means comprises two opposite contact elements configured to pick up the cargo by means of contacting the cargo, wherein at least one of the contact elements is configured to be moved in the direction of the cargo by means of a rotational movement. A corresponding rotational movement can be actuated simply and with little complexity.

According to further embodiments according to the first aspect of the present invention, the pick-up means comprises two opposite contact elements configured to pick up the cargo between the contact elements. The contact elements are mounted in a tiltable manner in order to adapt to an angle of inclination of a surface of the cargo. The inventors have recognized that the contact elements can establish better contact with the cargo in that way.

According to further embodiments according to the first aspect of the present invention, the contact elements are mounted eccentrically. This enables simple actuation of the delivery movement.

According to further embodiments according to the first aspect of the present invention, the pick-up means comprises at least one arm comprising a joint structure between a first arm element and a second arm element. Further, the apparatus is configured to change a relative inclination of the first arm element and the second arm element by means of the joint structure for picking up or putting down the cargo. The inventors have recognized that a robust and easy-to-actuate delivery movement of the contact elements can be provided in that way.

According to further embodiments according to the first aspect of the present invention, the apparatus is configured to comprise contact areas for establishing contact with a ground. Further, the apparatus is configured to provide the contact along exactly one axis of contact areas at least during a transport trip for transporting the cargo. In addition, the apparatus comprises a support structure for contact with the ground and control means configured to control the pick-up means to lift the cargo, starting from a first operating mode in which the contact areas and the support structure are in contact with the ground, and to switch to a second operating mode in which the support structure is lifted from the ground. The inventors have recognized that a particularly stable vehicle configuration, e.g. with a stable rest position, can thus be provided in the first operating mode, e.g. as a driving mode, and that a particularly dynamic drive can be enabled in the second operating mode.

According to further embodiments according to the first aspect of the present invention, the support structure is arranged away from the axis on the pick-up means. The inventors have recognized that a particularly stable vehicle configuration can be provided with respect to the vehicle balance in the first operating mode in that way.

According to further embodiments according to the first aspect of the present invention, the support structure includes an omniwheel and/or an omnidirectional wheel and/or a mecanum wheel. The inventors have recognized that a versatile driving mode can be provided in the first operating mode in that way.

According to further embodiments according to the first aspect of the present invention, the apparatus is configured to assume an unstable equilibrium state in the second operating mode. The inventors have recognized that this enables a particularly dynamic driving mode, for example with picked-up cargo.

According to further embodiments according to the first aspect of the present invention, the apparatus is configured to control the pick-up means into a rotational movement from a lying position in order to thereby raise the apparatus from the lying position. The inventors have recognized that this can enable an autonomous change from the first to the second operating mode.

According to further embodiments according to the first aspect of the present invention, the apparatus is configured to at least temporarily use a shovel or a fork as part of the pick-up means in order to transport the cargo. The inventors have recognized that the apparatus can thus be used for a plurality of possible cargo goods, i.e. with a high degree of flexibility.

According to further embodiments according to the first aspect of the present invention, the pick-up means is configured to lift the cargo including transport means and cargo arranged in the transport means and to move the cargo with one movement. Further, the apparatus comprises control means configured to keep an acceleration force of the cargo, acting under the influence of the movement, relative to the transport means within a tolerance range in a predefined orientation during the movement of the load by providing a balancing movement. The inventors have recognized that spillable loads can thus also be accelerated at least approximately in such a way that the same cannot get out of the, for example, open transport means.

For example, high accelerations can be unproblematic as long as the acceleration vectors are normal to the surface of the cargo, e.g. a box or a traversed ground, e.g. the “floor”. For example, high translational accelerations can be achieved by tilting, without significant lateral accelerations acting on the cargo, e.g. the load.

According to further embodiments according to the first aspect of the present invention, the balancing movement includes at least one of an inclination of the apparatus, for example by inclining a chassis or by causing pressure changes in the tires of the apparatus, rotation of the pick-up means, for example with respect to the platform, tilting of the transport means by a rotational relative movement of two arms of the pick-up means with respect to each other, and/or tilting of the transport means by a rotational movement of an eccentrically mounted contact area on an arm of the pick-up means. The inventors have recognized that corresponding balancing movements enable efficient stabilization of the orientation.

According to further embodiments according to the first aspect of the present invention, the mobile platform for moving on a ground comprises a set of wheels, wherein the apparatus comprises an actuator system connected to the set of wheels for adapting a size of a contact area of a wheel of the set of wheels with the ground, and wherein the apparatus comprises control means for controlling the actuator system, wherein the control means is configured to change the size of the contact area of the wheel by means of the actuator system in dependence on at least one of a driving speed of the apparatus, a change of a direction vector of the apparatus, properties of the ground and/or a ground condition. The inventors have recognized that energy requirements and/or stabilization or balancing effort of the apparatus can be kept to a minimum by means of a dynamic adjustment of the contact area.

For example, relevant or even the most important factors or characteristics of the ground can be a topology and elasticity of the ground, wherein topology can include or contain both regular, e.g. structurally determined features (e.g. gaps in a paving stone profile) or random ones (e.g. small stones or bumps).

For example, the ground can provide an excitation that can be addressed by means of the natural frequency. For example, a natural frequency of the apparatus can be changed by adapting a size of a contact area of a wheel. Alternatively or additionally, for example, “bumps” of the ground can be compensated for.

According to further embodiments according to the first aspect of the present invention, the control means is configured to set a first size of the contact area by means of the actuator system at a first movement speed and to set a second size of the contact area that is larger than the first size at a second movement speed that is lower than the first movement speed. The inventors have recognized that energy can be saved by adapting the contact area to the driving speed.

According to further embodiments according to the first aspect of the present invention, the control means is configured to adapt an air pressure of the wheel by means of the actuator system to change the size of the contact area. The inventors have recognized that when using air-filled tires, an adjustment of the contact area can be activated by compressed air means.

A further finding of the present invention is that pick-up means equipped with two arms is also advantageous independently of the equally advantageous implementation with an inverted pendulum. The inventors have recognized that by using two arms, a plurality of cargo goods can be lifted, for example without any special requirements for the configuration of the cargo. In this way, a plurality of cargo goods can be picked up or clamped between the arms in a form-fitting and/or force-fitting manner. Further, the cargo can be lifted from a wide variety of heights or put down at a wide variety of heights. Further, such a process can be automated or autonomous.

Embodiments according to a second aspect of the present invention include an apparatus for transporting cargo, the apparatus includes a mobile platform and pick-up means arranged on the mobile platform, the pick-up means comprising at least two arms and being configured to lift the cargo using the two arms by picking up the cargo between the two arms.

A further finding of the present invention is that, even independently of the nevertheless advantageous implementation with an inverted pendulum, generating a balancing movement in relation to acceleration forces acting on the cargo offers advantages, in particular with regard to preventing any spillage of load. The inventors have recognized that spillable cargo can thus be kept within the transport container by means of the balancing movement, but at the same time high accelerations and agile vehicle dynamics can be made possible. The balancing movement can, for example, include an acceleration of the mobile platform and/or a relative movement between pick-up means and mobile platform. Further, contact elements of the pick-up means can also be activated, for example, in order to introduce acceleration. Further, a particularly stable driving behavior can be achieved. For example, it is possible to prevent moving cargo goods from rolling around inside the transport container. In addition, movement of the cargo can be prevented from swinging up.

Embodiments according to a third aspect of the present invention include an apparatus for transporting cargo, wherein the apparatus comprises a mobile platform and pick-up means movably arranged on the mobile platform and configured to lift the cargo including the transport means and cargo arranged in the transport means. Further, the apparatus comprises control means and is configured to move the cargo with one movement. In addition, the control means is configured to keep an acceleration force of the cargo, acting under the influence of the movement, relative to the transport means within a tolerance range in a predefined orientation during the movement of the cargo by providing a balancing movement.

A further finding of the present invention is that, irrespective of the nevertheless advantageous configuration of the pick-up means of the first aspect, temporary support of the inverted pendulum has advantages in terms of stability, for example when stationary or at rest. The inventors have recognized that the support structure can be used to provide a particularly stable vehicle configuration in a first operating mode. Thus, for example, a driving mode can be provided (e.g. without load) in which the vehicle can navigate in an inherently stable manner. In the event of a balancing control failure, for example, a corresponding vehicle would not “fall over”. Such an operating mode can therefore be used, for example, in particularly safety-critical areas to move the apparatus from one location to another, e.g. in areas where people work.

Further, it is also possible to switch to the second operating mode when picking up the cargo, for example with an unstable rest position. In this way, high vehicle dynamics can be achieved. A synergetic advantage can lie in the dual use of the pick-up means both as a support for an inherently stable vehicle configuration and for cargo pick-up. Thus, a corresponding apparatus can be provided with little hardware effort.

Embodiments according to a fourth aspect of the present invention include an apparatus for transporting cargo, wherein the apparatus includes a mobile platform, the mobile platform comprising a set of wheels on an axis for movement on a ground. Further, the apparatus comprises a pick-up means arranged on the mobile platform, wherein a support structure for contact with the ground is arranged on the pick-up means. In addition, the apparatus comprises control means configured to control the pick-up means to lift the cargo, starting from a first operating mode, in which the set of wheels and the support structure are in contact with the ground, and to switch to a second operating mode, in which the support structure is lifted from the ground.

According to further embodiments according to the fourth aspect of the present invention, the set of wheels is a first set of wheels; wherein the support structure comprises a second set of wheels and wherein the second set of wheels is in contact with the ground in the first operating mode. The inventors have recognized that the use of wheels has advantages in terms of wear and agility.

A further finding of the present invention is that, irrespective of the nevertheless advantageous configuration of the pick-up means or the inverted pendulum of the first aspect, adapting the contact area size of wheels brings several advantages for the apparatus: temporary support of the inverted pendulum, advantages in terms of stability, for example when stationary or at rest.

Embodiments according to a fifth aspect of the present invention include an apparatus with a mobile platform, wherein the mobile platform comprises a set of wheels for movement on a ground and an actuator system connected to the set of wheels for adapting a size of a contact area of a wheel of the set of wheels with the ground. Further, the apparatus comprises control means for controlling the actuator system, wherein the control means is configured to change the size of the contact area of the wheel by means of the actuator system in dependence on a driving speed of the apparatus, a change of a direction vector of the apparatus, of properties of the ground, or in dependence on a ground condition.

According to further embodiments according to the fifth aspect of the present invention, the control means is configured to set a first size of the contact area by means of the actuator system at a first movement speed; and to set a second size of the contact area that is larger than the first size at a second movement speed that is lower than the first movement speed. The inventors have recognized that this can increase stability and/or energy requirement.

According to further embodiments according to the fifth aspect of the present invention, the control means is configured to adapt an air pressure of the wheel by means of the actuator system in order to change the size of the contact area. The inventors have recognized that when using air-filled wheels with a compressed air apparatus, adaptation of the contact area can be carried out with little effort and at high speed. This means that the contact area can be used as a fast input quantity of the regulation.

According to further embodiments according to the fifth aspect of the present invention, the apparatus is configured to transport cargo; and the control means is configured to change the size of the contact area of the wheel by means of the actuator system in dependence on a loading state of the apparatus. This enables the adaptation of, for example, adhesive forces, resisting forces, a vehicle inclination or the like depending on the load.

According to further embodiments according to the fifth aspect of the present invention, pick-up means are arranged on the mobile platform and the apparatus is configured to lift the cargo by means of the pick-up means in order to transport the lifted cargo.

Generally, embodiments according to the present invention include apparatuses that are an automated guided vehicle.

Inventive methods will be explained below. It should be noted here that corresponding methods can be based on the same or similar considerations as associated apparatuses and the methods can thus be supplemented accordingly or in an analogous manner by all features, functionalities and details of the apparatuses explained above, individually or in combination.

Embodiments according to the first aspect of the present invention include a method for transporting cargo, comprising lifting the cargo by means of a pick-up means, wherein the pick-up means is arranged on a mobile platform and wherein the mobile platform is configured as an inverted pendulum, and transporting the lifted cargo.

Embodiments according to the second aspect of the present invention include a method of transporting cargo, comprising picking up the cargo between at least two arms of a pick-up means, wherein the pick-up means is arranged on a mobile platform, and lifting the cargo using the two arms.

Embodiments according to the third aspect of the present invention include a method for transporting cargo, comprising lifting the cargo by means of pick-up means movably arranged on the mobile platform, wherein the cargo includes transport means and cargo arranged in the transport means, and moving the cargo with one movement and providing a balancing movement, by means of control means, during the movement of the cargo in order to keep an acceleration force of the cargo, acting under the influence of the movement, relative to the transport means within a tolerance range in a predefined orientation.

Embodiments according to the fourth aspect of the present invention include a method for transporting cargo, comprising controlling pick-up means for lifting the cargo, starting from a first operating mode in which a set of wheels and a support structure are in contact with a ground, to thereby switch to a second operating mode in which the support structure is lifted from the ground. Here, the pick-up means is arranged on a mobile platform and the support structure for contact with the ground is arranged on the pick-up means. Further, the mobile platform comprises a set of wheels on an axis for movement on a ground.

Embodiments according to the fifth aspect of the present invention include a method comprising controlling an actuator system by means of control means to change the size of a contact area of a wheel of a set of wheels by means of the actuator system in dependence on a driving speed of a mobile platform, a change of a direction vector of the mobile platform or in dependence on a ground condition. The mobile platform comprises the set of wheels for movement on the ground and the actuator system for adapting the size of the contact area of the wheel of the set of wheels with the ground is connected to the set of wheels.

### BRIEF DESCRIPTION OF THE DRAWINGS

Embodiments of the present invention will be detailed subsequently referring to the appended drawings, in which:

FIG. 1 is a schematic side view of an apparatus for transporting cargo according to embodiments according to the first aspect of the present invention;

FIG. 2 is a schematic view of an apparatus for transporting cargo with two leg elements according to embodiments according to the first aspect of the present invention;

FIG. 3a-b are a schematic view and a schematic side view of the apparatus of FIG. 2 with cargo between leg elements of the mobile platform;

FIG. 4 is a schematic side view of an apparatus for transporting cargo with a further pendulum segment according to embodiments according to the first aspect of the present invention;

FIG. 5a-d are schematic views of the apparatus of FIG. 2 in various states;

FIG. 6 is a schematic view of an apparatus for transporting cargo with bellows according to embodiments according to the first aspect of the present invention;

FIG. 7a-c are schematic views of pick-up means according to embodiments according to the first aspect of the present invention;

FIG. 8a-b are schematic views of pick-up means with eccentric according to embodiments according to the first aspect of the present invention;

FIG. 9a-d are schematic views of further pick-up means according to embodiments according to the first aspect of the present invention;

FIG. 10a-c are schematic views of further pick-up means with an articulated arm according to embodiments according to the first aspect of the present invention;

FIG. 11a-e are schematic side views of an apparatus for transporting cargo with a support structure according to embodiments according to the first aspect of the present invention;

FIG. 12a-c are schematic side views of an apparatus for transporting cargo with rotatable grippers according to embodiments according to the first aspect of the present invention;

FIG. 13a-c schematic views of load transport tools according to embodiments according to the first aspect of the present invention;

FIG. 14a-b are schematic views of an apparatus for transporting cargo including transport means and load arranged in the transport means according to embodiments according to the first aspect of the present invention;

FIG. 15 is a schematic view of an apparatus for transporting cargo with an actuator system for adapting a size of a contact area of a wheel according to embodiments according to the first aspect of the present invention;

FIG. 16 is a schematic view of an apparatus for transporting cargo according to embodiments according to the second aspect of the present invention;

FIG. 17 is a schematic view of an apparatus for transporting cargo according to embodiments according to the third aspect of the present invention;

FIG. 18 is a schematic view of an apparatus for transporting cargo according to embodiments according to the fourth aspect of the present invention;

FIG. 19a-b are schematic views of an apparatus for transporting cargo according to embodiments according to the fifth aspect of the present invention;

FIG. 20a-d are plots according to embodiments comprising an actuator system for adapting a contact area of a wheel;

FIG. 20e is an example of a wheel before and after releasing air pressure; according to an embodiment; and

FIG. 21a-c are schematic views of dynamic states of an apparatus according to embodiments with an actuator system for adapting a contact area of a wheel.

### DETAILED DESCRIPTION OF THE INVENTION

Before embodiments of the present invention will be explained in more detail below with reference to the drawings, it should be noted that identical, functionally identical or equal elements, objects and/or structures in the various figures are provided with the same or similar reference numbers, so that the description of these elements shown in different embodiments is interchangeable or interapplicable.

In the following, a basic concept of the vehicle kinematics according to the invention is first described in general terms and then further inventive developments according to the invention for fulfilling further functions or, for example, the main function (e.g.: picking up, transporting and putting down cargo goods) are described.

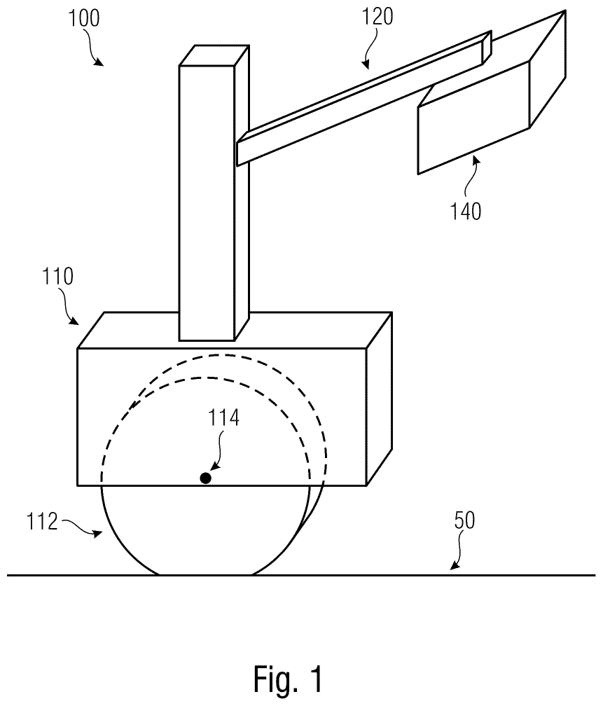

FIG. 1 shows a schematic side view of an apparatus for transporting cargo according to embodiments according to the first aspect of the present invention. FIG. 1 shows the apparatus 100 including a mobile platform 110, as well as pick-up means 120 arranged on the mobile platform.

The mobile platform is configured to move without a driver, i.e. automatically, remotely controlled or autonomously. For this purpose, the platform comprises at least one wheel 112 as an optional feature. Further, however, an inventive mobile platform can also comprise several wheels or other apparatuses for establishing ground contact with a ground 50.

The mobile platform is configured as an inverted pendulum. For example, several wheels can be arranged along or on a vehicle axis. An axis of rotation of the pendulum can, for example, form a wheel axis 114 of the wheel 112. The apparatus can thus be configured to hold or balance the mobile platform in an upright position by controlling the wheel 112 by means of torques.

By means of the pick-up means 120, the apparatus is configured to lift cargo 140 so that the cargo can be transported. The cargo can comprise any object. These include, for example, crates, boxes, but also pallets or other objects that are to be transported from one location to another or to be lifted while remaining in one position, in particular but not exclusively in the field of logistics. For moving and/or balancing, the apparatus 100 can, for example, perform a pendulum movement so that the pick-up means 120 for picking up the cargo 140 swings or oscillates in the direction of the cargo 120. Due to the positioning of the center of gravity, starting from the traversed ground 50 above the wheel, an inverted pendulum is obtained. Further, the pick-up unit 120 itself can be actuated to facilitate or enable lifting of the cargo 140.

The pick-up means 120 can be configured as a single arm as shown in FIG. 1. As an example, a contact for lifting the cargo could be established, for example, via a magnet or a hook that is dynamically hooked into an eye of the cargo. In configurations with several arms, several contact areas can also be used so that a frictional and/or form fit can be established with the cargo 140.

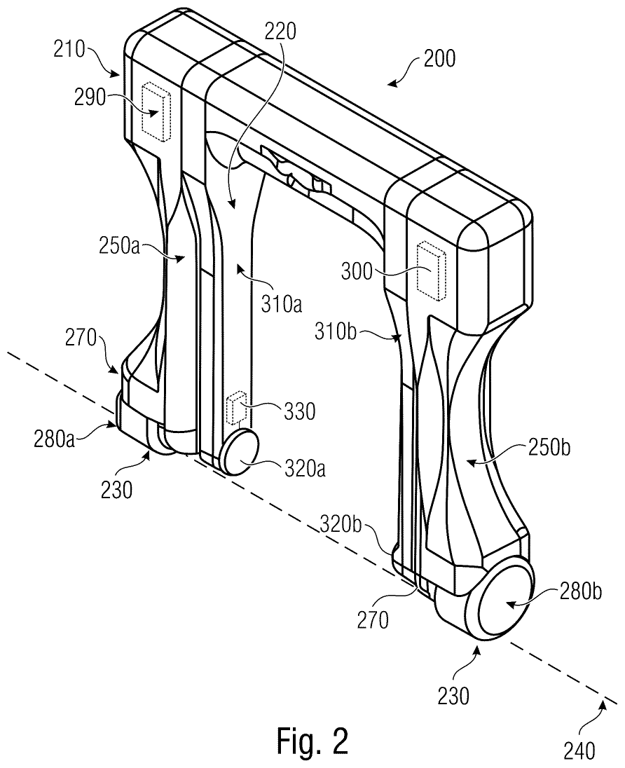

FIG. 2 shows a schematic view of an apparatus for transporting cargo with two leg elements according to embodiments in accordance with the first aspect of the present invention. FIG. 2 shows an apparatus 200 including a mobile platform 210 configured as an inverted pendulum and a pick-up means 220 arranged on the mobile platform. The apparatus 200 is configured to lift cargo using the pick-up means 210 and to hold the same in a lifted state and/or to transport the same to another location. Accordingly, the apparatus can also unload or put down the cargo again. In particular, cargo can be lifted from a ground (on which the apparatus 200 moves, for example) or unloaded onto the ground, for example the ground 50. For this purpose, the pick-up means 220 can optionally be activated and configured to lift cargo accordingly from any height within reach of the pick-up means or to unload the same at such a height.

As a further optional feature, the apparatus 200 comprises contact areas 230 for establishing contact with the ground. The apparatus 200 is configured to provide contact along exactly one axis 240 of contact areas 230, at least during a transport trip for transporting the cargo. Accordingly, the mobile platform is in contact with the ground via two contact areas 230, for example, during transport of the cargo. For example, the platform can have contact with the ground via exactly two contact areas during transport of the cargo. Accordingly, possible further contact areas according to such embodiments are located on the same axis 240 during transport. The uniaxial arrangement of the contact areas 230, at least during transport, enables good dynamics of the apparatus in the sense of an inverted pendulum.

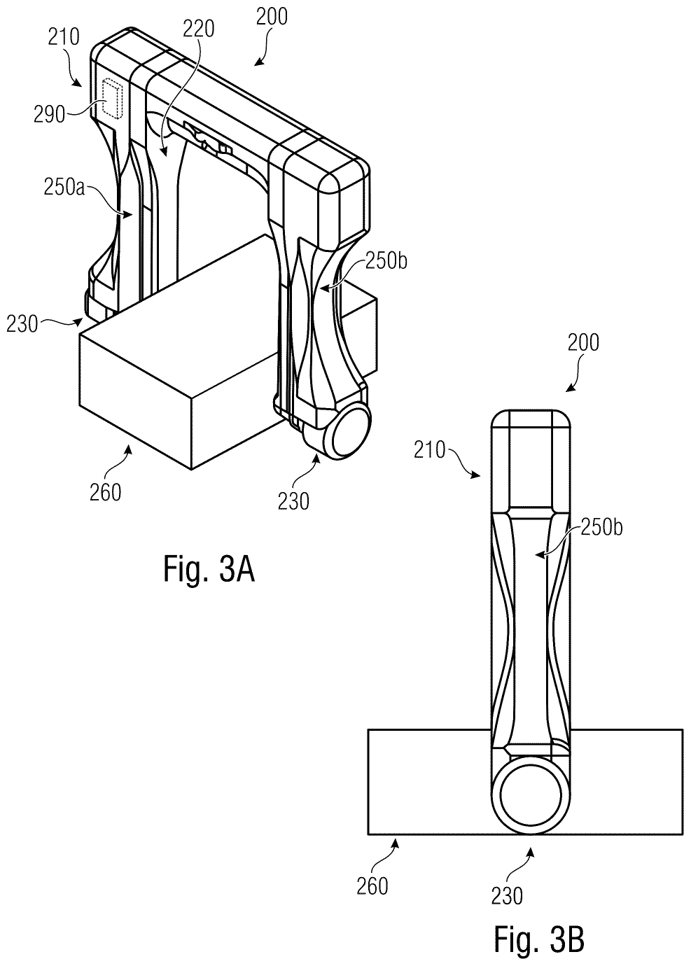

As a further optional feature, the mobile platform 210 comprises two leg elements 250a, 250b arranged substantially parallel to each other and spaced apart from each other in a floor region. The apparatus 200 is also further configured to position the cargo at least temporarily between the leg elements 250a, 250b. Reference is made here to FIG. 3a) and FIG. 3b).

FIG. 3a shows a schematic perspective view and FIG. 3b a schematic side view of the apparatus of FIG. 2 with cargo 260 between leg elements of the mobile platform. For example, to lift the cargo, the apparatus 200 can drive over the cargo 260 in order to subsequently lift the cargo 260 with the pick-up means 220. Accordingly, cargo 260 can be lifted from or placed on a ground. It should be noted that in FIG. 3a and FIG. 3b not all optional elements according to FIG. 2 are marked for improved clarity, but the same can be present individually or in combination.

As a further optional feature, the apparatus 200 comprises, as designated in FIG. 2 and also shown in FIG. 3a and FIG. 3b, a chassis 270 with a set of wheels. Here, a first subset 280a of the set of wheels is arranged on a first leg element 250a and a second subset 280b of the set of wheels, disjoint to the first subset, is arranged on a second leg element 250b. In simple terms, one wheel is arranged on each of the leg elements 250a, 250b. The wheels can in turn each provide a contact area 230. Accordingly, in one configuration, the wheels of the apparatus 200 are located on exactly one axis. Consequently, embodiments according to FIG. 2 can manage with only two wheels, wherein the apparatus can be balanced by means of suitable regulation technology based on a regulation concept for an inverted pendulum with and/or without cargo both when stationary and during a drive, for example to prevent falling over. This means that the apparatus 200, for example, needs few hardware components (such as wheels), which means that the structure can be provided at low cost and with few wearing parts.

For example, embodiments include exactly one axis of wheels, so that there is no 3-point (triangle) or 4-point (quadrilateral) system during the drive, i.e. a system with 3 or 4 contact areas, for example, which are not all located on the one axis.

Thus, embodiments include a vehicle that is mechanically simple in principle (although complex in its technical implementation, for example), which can fulfill a wide range of functions with a few very flexibly usable assemblies. Optionally, special emphasis can be placed on the regulation concepts and algorithms needed for the challenging motion sequences.

As a further optional feature, the apparatus 200 comprises control means 290 configured to balance the apparatus 200 and the cargo 260 using additional information. For example, the control means 290 can be configured to control the apparatus using a regulation law and/or based on sensor information. A model of the apparatus 200 can optionally be stored in the control means, on the basis of which the regulation is executed. A variety of regulation concepts can be used here, e.g. PID regulators (proportional-integral-derivative regulators), state regulators, predictive control concepts, optimal regulators (which optimize a quality function, for example), non-linear regulators, e.g. fuzzy regulators, and/or regulation concepts based on machine learning approaches.

The additional information can include at least one of loading state of the apparatus 200, a speed of the apparatus 200, an acceleration of the apparatus 200, an inclination of the mobile platform 210, for example relative to the ground, relative to other components of the apparatus 200 or relative to the cargo 240 in an intended or actual orientation, an orientation of the pick-up means 220 relative to the mobile platform 210, a relative movement of the pick-up means 220 relative to the mobile platform 210, a relative movement of the cargo 260 with respect to the mobile platform 210, a weight of the cargo 260, a center of gravity of the cargo 260 (e.g. position of the cargo 260 in space or with respect to the apparatus 200), a torque in an actuator of the apparatus 200, information about the geometry of the cargo 260, and/or information about the type of cargo 260. In particular, the additional information can include information about a size of the cargo 260, about a weight of the cargo 260 and/or about torques in actuators of the apparatus 200.

More generally, in apparatuses 200 according to embodiments, the contact areas 230 of the first and second subsets of the set of wheels with the ground can form the one axis 240 of contact areas, and further, the axis 240 of contact areas or an axis of the associated wheels can form an axis of rotation of the inverted pendulum. Accordingly, the apparatus can be configured, e.g., by means of control means 290, to apply torques to the first and second sets of wheels to balance the apparatus 200 and the cargo 260 over the axis 240 of contact areas or the axis of wheels.

Further, it should be noted that optionally a respective apparatus 200 or associated control means 290 can be configured to effect a relative movement between the pick-up means 220 and the mobile platform 210 to balance the apparatus 200 and the cargo 260 over the axis 240 of contact areas 230 or the axis of wheels. Here, it becomes clear that the task of balancing during lifting on the one hand and/or during a change of a direction vector (such as acceleration, deceleration, change of direction, combinations thereof), the control for balancing advantageously takes into account the changed states.

In general terms, the vehicle concept according to embodiments thus comprises an automated guided transport vehicle, e.g. 200, for the transport of cargo goods, e.g. 260, which in its basic form uses the principle of an inverted pendulum for movement: The vehicle can optionally, as shown in FIG. 2, comprise two driven wheels hanging from long “legs”, e.g. 250a, 250b. The center of gravity of the vehicle can be higher than the wheels. The vehicle can balance by regulated movements of the drives and can thus move along. Accordingly, apparatus 200 can comprise respective driving means for applying torques to the wheels.

Even if the additional information can be received, for example, via a communication interface, the apparatus 200 comprises sensor means 300 as a further optional feature, configured to detect the parameters on which the additional information is based and to provide a sensor signal based thereon. Further, the control means can be configured accordingly to balance the apparatus 200 and the lifted cargo 260 based on the sensor signal. The sensor means 300 can comprise a plurality of sensors, such as weight sensors, torque sensors, optical sensors (e.g. laser sensors, radar sensors, ultrasound sensors), acceleration and/or position sensors. The sensors can be mounted at different locations on the apparatus 200 (e.g. torque sensors on the wheels and optical sensors e.g. at an upper end of the mobile platform to provide a good viewing radius).

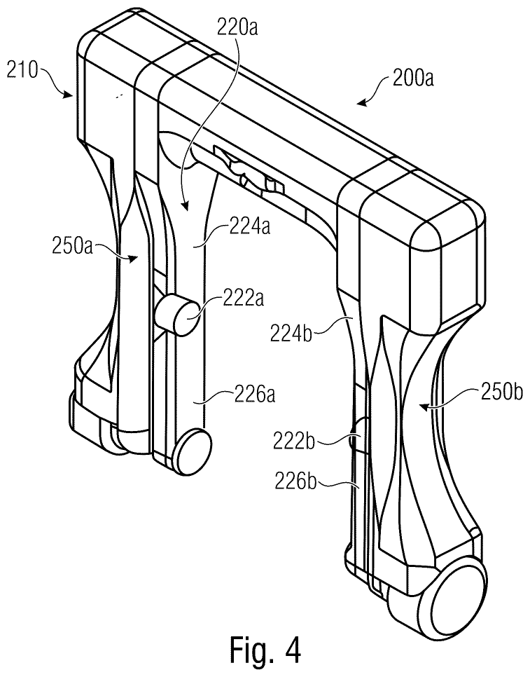

As a further optional feature, the pick-up means can provide at least one additional pendulum segment. Reference is made here to FIG. 4. FIG. 4 shows a schematic side view of an apparatus 220a for transporting cargo with a further pendulum segment according to embodiments according to the first aspect of the present invention. The apparatus 200a optionally includes, apart from some of the features already explained in connection with the apparatus 200, pick-up means 220a, which are subdivided by additional joints 222a and 222b relative to the pick-up means 220. Thus, the pick-up means 220a comprises at least two pendulum segments 224a, 224b and 226a and 226b each, wherein the elements 226a and 226b can each form additional pendulum segments of the apparatus 200a. The joints can, for example, be actuated (e.g. controlled by sensor means).

Additional degrees of freedom of movement can be provided by the pick-up means 220a by means of additional pendulum segments. This can have advantages, for example, when loading shelves, since pendulum segments 226a and 226b can be used to push cargo as far as possible into a shelf compartment. Further, an inventive apparatus can also be configured to stabilize itself on an object by means of the pick-up means, for example to support itself on a shelf in order to be able to push cargo further into a shelf compartment.

It should be noted that not all optional elements as shown in FIG. 2 are marked in FIG. 4 for improved clarity, but the same can be present individually or in combination.

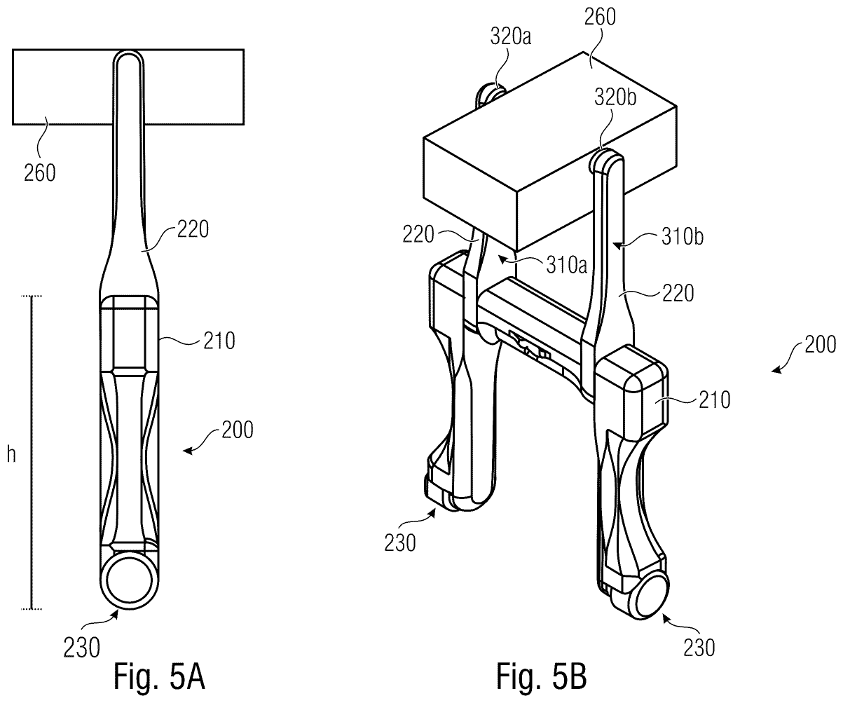

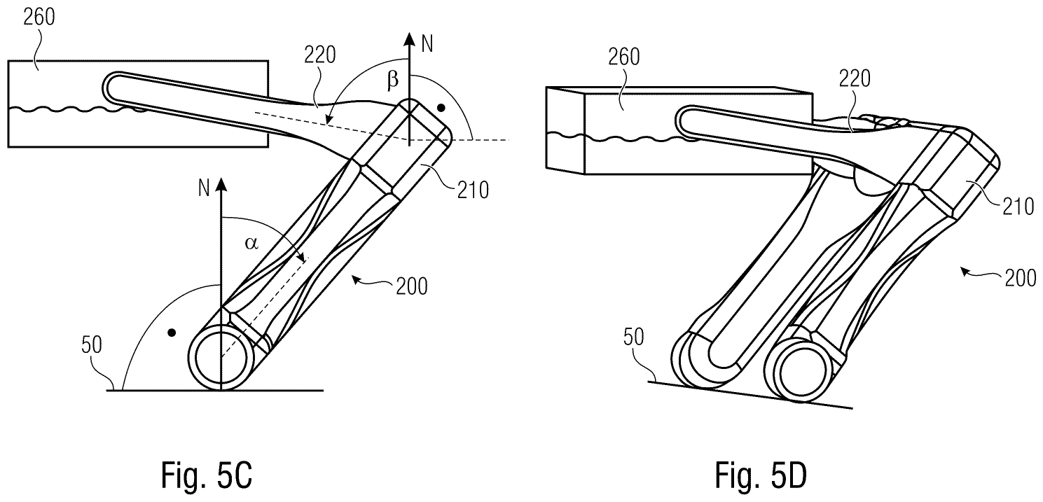

As a further optional feature, the apparatus 200 or 200a can be configured to raise the cargo to a height above a platform height in relation to a traversed ground during a transport trip. Reference is made here to FIG. 5.

FIGS. 5a-d show schematic views of the apparatus in FIG. 2 in various states. It should be noted that in FIGS. 5a-d not all optional elements according to FIG. 2 are marked for improved clarity, but the same can be present individually or in combination.

In a first state, see FIG. 5a, the apparatus 200 can transport the cargo “overhead”, for example, so that the cargo 260 is transported above a height h of the platform. FIG. 5b shows a further view for this case. Thus, for example, the cargo 260 can be balanced above the contact areas 230 when stationary or moving uniformly, so that a common center of gravity of the apparatus 200 and the cargo 260 lies above the contact areas.

However, as a further optional feature, the apparatus 200 can also be configured to align the mobile platform 210 relative to a surface normal N of a traversed ground 50 along a first direction (e.g., at a positive angle α) and along a driving direction or opposite thereto; and to align the pick-up means 220 relative to the surface normal N opposite (e.g., at a negative angle β) to the first direction.

Thus, a common center of gravity of cargo 260 and apparatus 200 can also be maintained above the contact areas 230 (and in general optionally for all embodiments above a possible wheel axis, which is located, for example, perpendicular above the contact areas—i.e. parallel to the axis of the contact areas) during uniform movement.

Such a position can have particular advantages when accelerating and decelerating the apparatus, so that a robust balance of the apparatus 200 with or without cargo 260 can be obtained by adapting the inclination angles.

Here, the mobile platform configured as an inverted pendulum will be discussed again in general terms. As already explained above, a common axis of rotation of the wheels of the apparatus 200 can form an axis of rotation of the inverted pendulum. Such a pendulum can be subdivided into a pendulum rod and a pendulum weight for clear explanation. The pendulum rod can then be, for example, the mobile platform comprising the legs 250a and 250 and a corresponding chassis or robot frame connecting the legs.

An additional movable, e.g. actuated, pick-up means 220 can form an additional input quantity in a regulation model of the inverted pendulum, while any cargo 260 and/or an acceleration can in turn form a disturbance. Accordingly, it should be noted that a corresponding structure according to, for example, FIG. 2 can thus optionally also be understood as an overall construct as an inverted pendulum. In this regard, the inventors have recognized that a corresponding actuation of the pick-up means 220 on the one hand enables cargo 260 to be picked up and/or put down and at the same time can be used, for example, to balance the apparatus 200 by means of a relative movement between the platform 210 and the pick-up means 220 and thus possibly also the cargo 260.

Thus, in general, embodiments according to the present invention can also include multi-pendulums, with any number of pendulum segments, which can, for example, be optionally actuated. Thus, both leg elements and pick-up means segments can optionally comprise additional actuated joints.

As a further optional feature, the pick-up means 220 (see, for example, FIG. 2 and FIG. 5b) includes at least two arms 310a, 310b and is configured to lift the cargo 260 using the two arms by picking up the cargo between the two arms. Optionally, the arms 310a, 310b can comprise further joints and form one or several pendulum segments. By means of the arms, as explained above, the cargo can be picked up and put down from different heights and at the same time a relative movement between arms 310a, 310b and platform 210 can be caused in order to balance. The arms 310a, 310b can also be used to balance acceleration forces on the cargo 260.

As a further optional feature, the control means 290 can be configured to control a first arm 310a and a second arm 310b of the at least two arms independently of each other, and/or to control the first arm and the second arm depending on each other. With independent actuation, for example, cargo 260, which comprises, for example, two different sides, can be lifted with adapted holding positions of the arms, so that even asymmetrical cargo goods can be transported safely. In particular, an asymmetrical center of gravity of the cargo 260 can be compensated for, for example.

With regard to embodiments with optional arms 310a, 310b, reference should again be made in other words to FIG. 3a and FIG. 3b: According to corresponding embodiments, the cargo pick-up thus functions, for example, by means of two “arms” movable independently of the “legs” 250a, 250b and which can, for example: pick up (e.g. clamp) cargo 260 via a gripping principle.

As shown in FIG. 5a-b, the cargo 260 can, for example, usually be lifted during transport and transported “overhead” or in a “bent” position. For example, due to the needed or advantageous inclination (see, for example, FIG. 5c and FIG. 5d) during a balancing movement and the therefore, for example, inherently purely or at least approximately vertically directed acceleration in the inertial system of the vehicle, potentially spillable goods can also be transported with high acceleration. The advantages can also be used for other cargo goods, but for the illustrative example of a possibly lidless tub with a liquid or similar filling (solid balls, sand, . . . ), the speed vector can only be changed slowly without a corresponding adaptation movement in order to prevent the cargo from spilling or sloshing out. With a corresponding adaptation movement, the speed vector can be changed correspondingly faster, which can lead to shorter driving times.

Another optional feature shown in FIG. 5-ad is an embodiment with a gripper that can be actively rotated in the arm in order to hold the cargo 260 in a horizontal (or a defined other) orientation. This is basically not necessary for the principle (e.g. for closed cargo goods, which can also be rotated), but increases the range of application enormously. While the mechanics can be kept relatively simple, complex regulation algorithms can be used or can even be needed for the control.

As a further optional feature, at least one of the at least two arms 310a, 310b comprises a contact element. As an optional example, FIG. 2 shows two arms 310a, 310b, each of which comprises a contact element 320a, 320b. Optionally, one of the contact elements 320a, 320b can comprise an elastic, in particular a viscoelastic material. At least one of the contact elements 320a, 320b can be configured to establish contact with the cargo and to adapt to a shape of the cargo in order to lift the cargo under the influence of the elastic material.

As shown in FIG. 2, an apparatus 200 according to embodiments can comprise, for example, exactly two arms 310a, 310b. Irrespective of whether the contact elements 320a, 320 comprise an elastic or viscoelastic material, the contact elements can be configured to establish a frictional fit and/or a force fit with the cargo. For this, the arms 310a, 310b can be actuated, for example, and can be configured to move towards each other in order to establish a frictional fit. Further, the contact elements 320a, 320b can be activated, for example, to reduce a distance between the two contact elements and thus also achieve a frictional fit with cargo located therebetween (see, for example, FIGS. 5a-d). Contact elements with elastic or viscoelastic material can also, for example, establish a form fit with the cargo in order to lift the cargo.

As a further optional feature, the contact elements 320a, 320b can be connected to an actuator means 330 and can optionally be rotatably mounted. Accordingly, the apparatus 200 can pick up the cargo 260 between the first contact element 320a for contacting the cargo and the second contact element for contacting the cargo by means of the pick-up means 220 (see, for example, FIG. 3 and FIG. 5). As shown in FIGS. 5a-d, the apparatus 200 can be configured to control the actuator means 330 during a lifting and/or during an acceleration of the cargo in order to rotate the first contact element 320a and the second contact element 320b in order to set an orientation of the cargo. Thus, as shown in FIGS. 5a-d, the cargo 260 can be held in the same orientation. Thus, for example, spillable goods in particular can also be transported in open containers.

In general, according to embodiments, there are a plurality of different solution variants for picking up cargo, which have different advantages depending on the expected range of cargo. In the possible range of applications, according to embodiments, cargo pick-up means with a high or, for example, the highest possible delivery path (e.g. in order to be able to pick up cargo goods of different sizes) and a low or, for example, the lowest possible weight in the arm can be provided or aimed for. Some cargo pick-up concepts or cargo pick-up principles in the arm, including, e.g., simple ones, will be presented below.

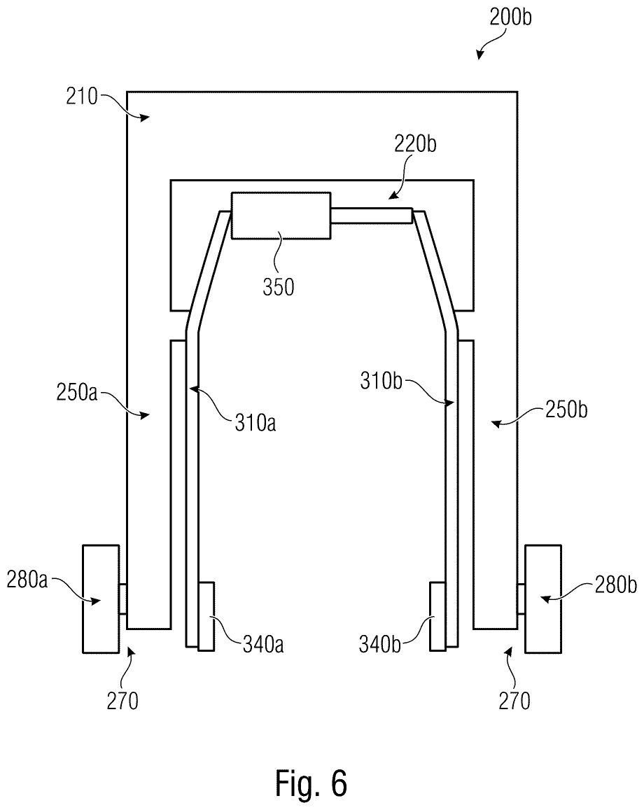

FIG. 6 shows a schematic view of an apparatus for transporting cargo with bellows according to embodiments according to the first aspect of the present invention. In addition to one or more of the features of the apparatus 200 of FIG. 2 already explained and still following, the apparatus 200b comprises pick-up means 220b with bellows 340a, 340b each arranged at one end of the pick-up means. It should be mentioned here that, according to embodiments, only one bellows, for example either 340a or 340b, can be used.

The bellows 340a, 340b are each configured to release the cargo in a first state and to adapt to a shape of the cargo in a second state to provide a form fit and/or a frictional fit with the cargo to lift the cargo. As a further optional feature, the bellows 340a, 340b can be pneumatic bellows. As a further optional feature, the pick-up means 220b comprises pneumatic means 350, which can be configured to place the bellows 340a and 340b in the first or second state, or, for example, in simple terms, to provide or release compressed air.

Here, it should be noted that the pick-up means 220b is merely an exemplary configuration. For example, the pick-up means 220b can also comprise a single, for example U-shaped bellows (e.g. with the opening of the U in the direction of the cargo), which encloses a corresponding cargo in the second state from above and on the sides in order to lift the same. Accordingly, the configuration of the apparatus 200b with the two arms 310a, 310b is also merely optional (for example, the arms 310a, 310b could be replaced by the U-shaped bellows).

In general, the one or more bellows can be, for example, shape reminder bellows.

In simple terms, embodiments can therefore include a clamping mechanism using pneumatic bellows. Under pressure, the bellows can expand and thus perform the delivery movement (e.g. transition from the first state to the second state). If pressure is released, the bellows can contract and the cargo can be put down (e.g. first state). The bellows can adapt to the outer contours of the cargo and can thus create a form fit, for example. At the same time, a material with a high friction coefficient can be used to enable friction-fit pick-up also with smooth surfaces.

With regard to the apparatus 200b, it should again be noted that the same can also comprise some or all of the optional features of the further disclosed embodiments, in particular the features disclosed in connection with FIG. 2.

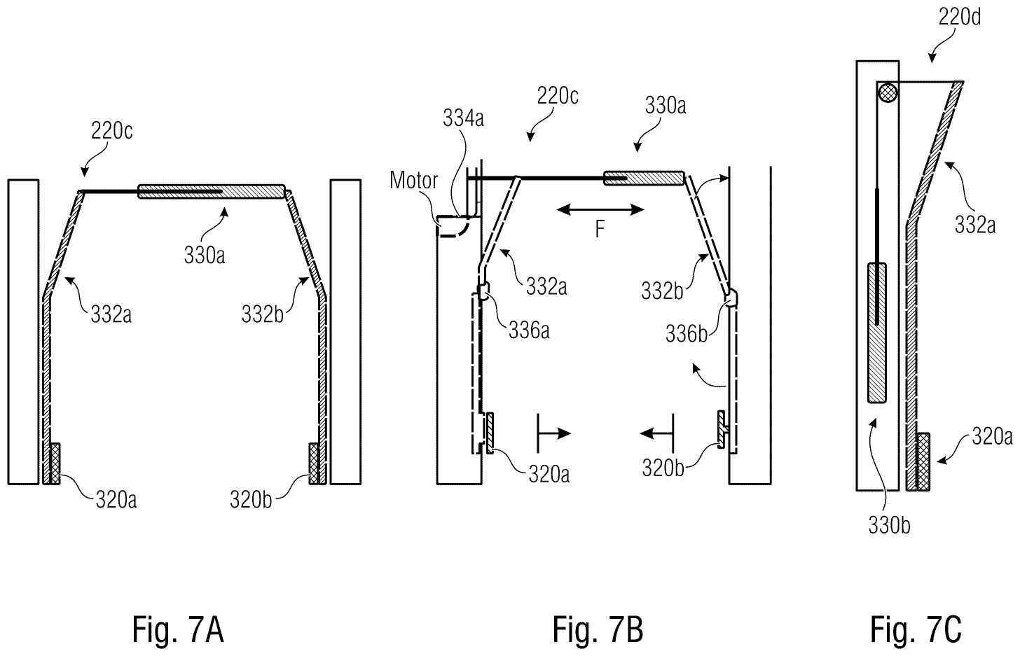

FIGS. 7a-c show schematic views of pick-up means according to embodiments according to the first aspect of the present invention. FIG. 7a shows pick-up means 220c with two opposite contact elements 320a, 320b, wherein the contact elements are configured to pick up the cargo between the contact elements. Further, the pick-up means 220c comprises actuator means 330a coupled to the contact elements 320a, 320b and arranged to move the two contact elements towards each other.

As an optional feature, the contact elements 320a, 320b are each coupled to the actuator means 330a by means of lever means 332a, 332b. Thus, the actuator means 330a can move, for example, the contact elements 320a, 320b towards each other by means of a linear movement using the lever means 332a, 332b, and thus provide a force fit or, for example, if the contact elements comprise bellows or a (visco-) elastic material, a form fit. Accordingly, the actuator means can comprise a linear actuator, for example. The lever means can be attached, for example, to arms of the pick-up means or corresponding arms can comprise the lever means 332a, 332b.

However, it should be noted that, according to embodiments, only one lever means can be configured. For example, moving parts can be saved by using only one moving contact element.

FIG. 7b illustrates the movement sequence. An optional motor 334a, for example as part of the actuator means 330a, can exert a force F so that an upper part of the lever means 332a, 332b move apart, so that the contact elements 320a and 320b move towards each other in accordance with the axes of rotation 336a and 336b of the levers.

In a configuration according to FIG. 7a and FIG. c, two contact elements can thus be controlled together and moved towards each other by one actuator. FIG. 7c shows a section of a further optional configuration of pick-up means 220d. Here, each contact element (here as example 320a) can be assigned its own actuator or its own actuator means 330d, so that the contact elements can be controlled individually. In this way, a delivery path of a respective contact element can be adapted, for example, to an asymmetrical nature of the cargo.

In other words, embodiments comprise mechanical grippers, which can be configured, for example, as shown in FIG. 7-ac.

For example, similar to the solution with the bellows, there can be a linear actuator (e.g. 330a, 334a, 330b) that either expands or contracts when actuated. This allows the corresponding delivery movement to be achieved via the levers (e.g. 332a, 332b). Two variants can be used, for example:
once with a linear actuator (e.g. 330a) that connects the two levers
once with a linear actuator (e.g. 330b) that is only attached to one lever.

This means, for example, that either an actuator can be saved or independent delivery movements can be performed.

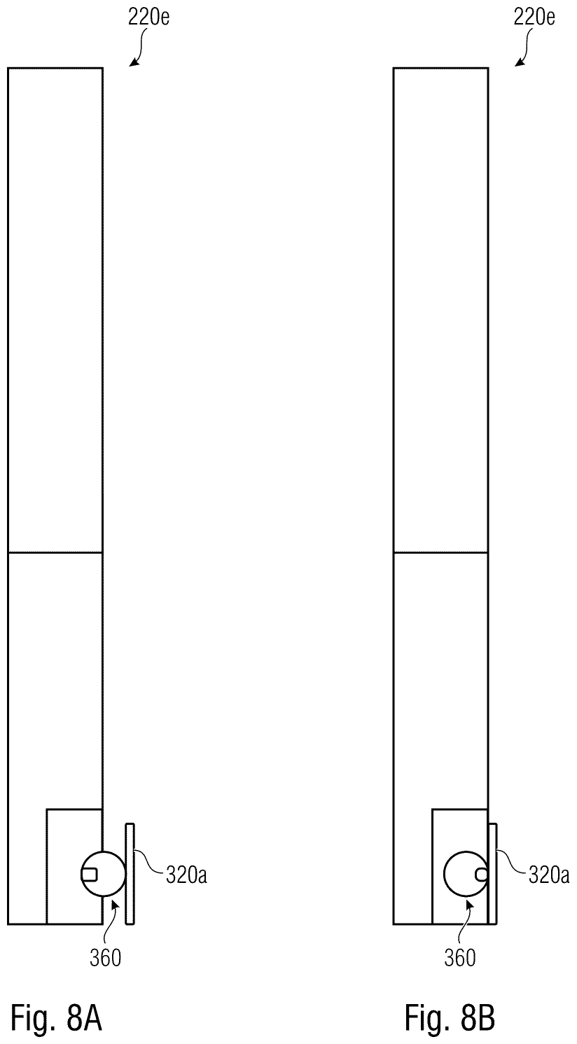

FIGS. 8a-b show schematic views of parts of pick-up means with eccentrics according to embodiments according to the first aspect of the present invention. FIGS. 8a-b each show part of pick-up means 220e with a contact element 320a. Here, the complete pick-up means 220e can comprise two opposite contact elements, which are set up to pick up the cargo by means of contacting the cargo.

As shown in FIG. 8 a-b, at least one of the contact elements 320a can be configured to be moved in the direction of the cargo by means of an eccentric 360. In this case, the gripper, for example an arm of the pick-up means 220e at the end of which the contact element 320a and the eccentric 360 are arranged, can itself perform a linear delivery movement. This can be achieved by an eccentric disk 360 and a corresponding rotational movement thereof.

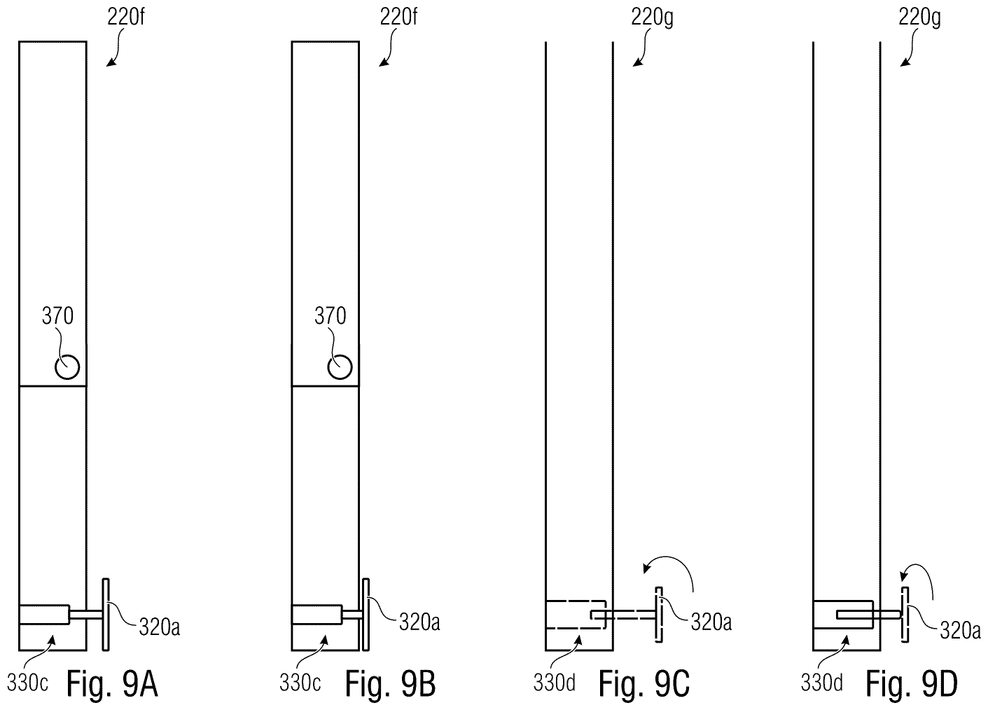

FIGS. 9a-d show schematic views of further pick-up means according to embodiments according to the first aspect of the present invention. FIGS. 9a-d show parts of pick-up means (220f in FIG. 9a and FIGS. 9b and 220g in FIGS. 9c-d)), for example one arm element each or an arm of a pick-up means.

As an optional feature, the pick-up means 220f includes an actuator 330c, configured to move a contact element 320a, for example by means of a linear movement. The pick-up means can comprise, for example, an articulated arm or be configured as such, as optionally indicated by the axis of rotation 370.

As an optional feature, the pick-up means 220g also includes an actuator 330d, wherein the actuator 330d is configured to move at least one of the contact elements 320a towards the cargo by means of a rotational movement. Optionally, the actuator can also be arranged away from the contact element 320a, and the contact element can be configured, for example, to be moved towards the cargo by means of a rotational movement.

For the sake of completeness, it should be noted that in embodiments according to FIGS. 9a-d, the pick-up means 220f, 220g can comprise two opposite contact elements which are set up to pick up the cargo by means of contacting the cargo. It should also be noted that the pick-up means 220g can also include an articulated arm.

In other words, embodiments according to FIG. 9a-d include an actuator for clamping. For example, cargo pick-up can be moved via a linear actuator and a delivery movement can be generated. The cargo can be clamped and lifted in a force-fit or alternatively/additionally form-fit manner. To rotate the cargo after it has been picked up, either the actuator itself can be rotated (actively via an additional motor on the flange) or a rotating element can be installed on the delivered element.

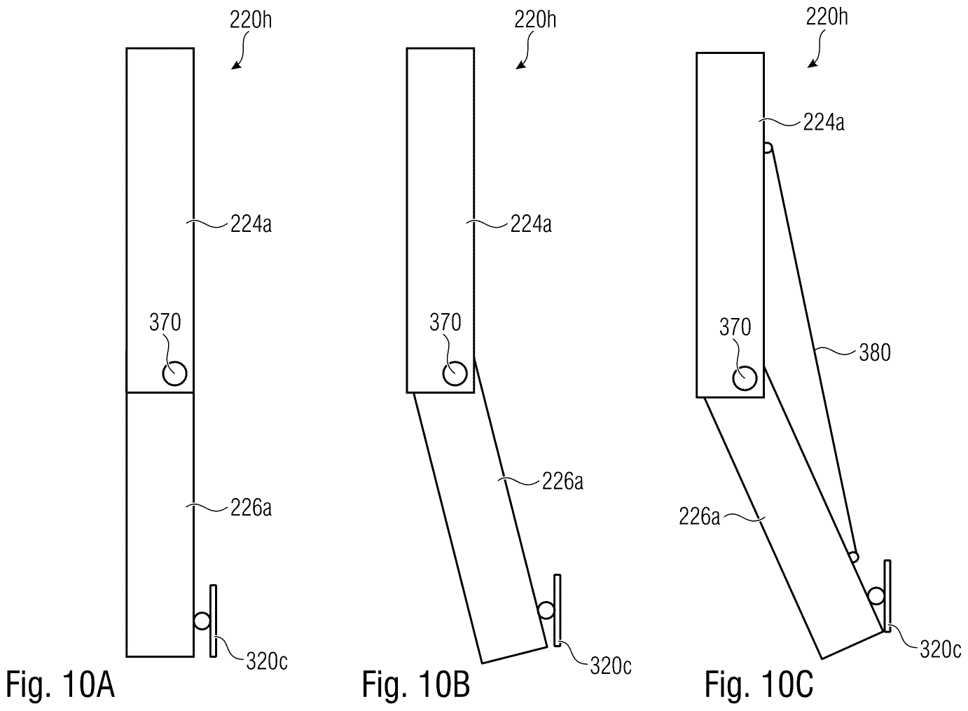

FIGS. 10a-c show schematic views of further pick-up means with an articulated arm according to embodiments according to the first aspect of the present invention. FIG. 10 shows a part of a pick-up means 220h, for example one arm element each or an arm of a pick-up means.

As a further optional feature, the pick-up means comprises contact elements 320c, which are mounted in a tiltable manner in order to adapt to an angle of inclination of a surface of the cargo.

For the sake of completeness, it should again be noted that in embodiments according to FIG. 10, the pick-up means 220h can comprise two opposite contact elements, which are set up to pick up the cargo by means of contacting the cargo. Thus, both or only one of the opposite contact elements can also be mounted in a tiltable manner.

It should also be noted that although the tiltable mounting can be particularly advantageous in the context of an articulated arm, tiltable mounting of contact elements is not limited to such a configuration. For example, tiltable contact elements can also be used in apparatuses with pick-up means according to FIG. 7. Optionally, the contact elements 320c can be mounted eccentrically.

Further, as an optional feature, the pick-up means 220h comprises an arm comprising a joint structure 370 between a first arm element 224a and a second arm element 226a. A respective inventive apparatus can be configured to change a relative inclination of the first arm element 224a and the second arm element 226a by means of the joint structure 370 in order to pick up or put down the cargo. The arm elements can thus form pendulum segments (e.g. corresponding to the apparatus 200a of FIG. 4).

An example of a change in inclination is shown with the transition from FIG. 10a to FIG. 10b to FIG. 10c. It should again be noted here that the configuration of the contact elements 320c in tiltable form is merely optional. For example, a (visco-) elastic material could also be arranged here as a contact element, without a tilting function of the contact elements, so that the form adaptation can be performed by the material.

FIG. 10c also shows a possible configuration of the tilting function of the arm by means of a rope hoist. However, a corresponding mechanism can also optionally be arranged within the arm as shown in FIG. 10a and FIG. 10b.

Accordingly, it can also be possible, for example, to use a joint 370 in the arm instead of a molded lever, irrespective of the actuator used, with which the delivery movement of the gripper, for example a contact element, is then made possible.

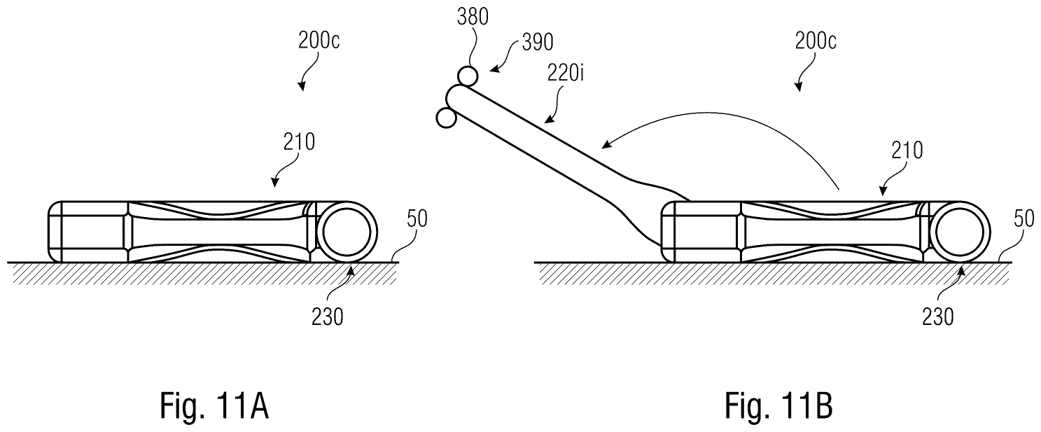

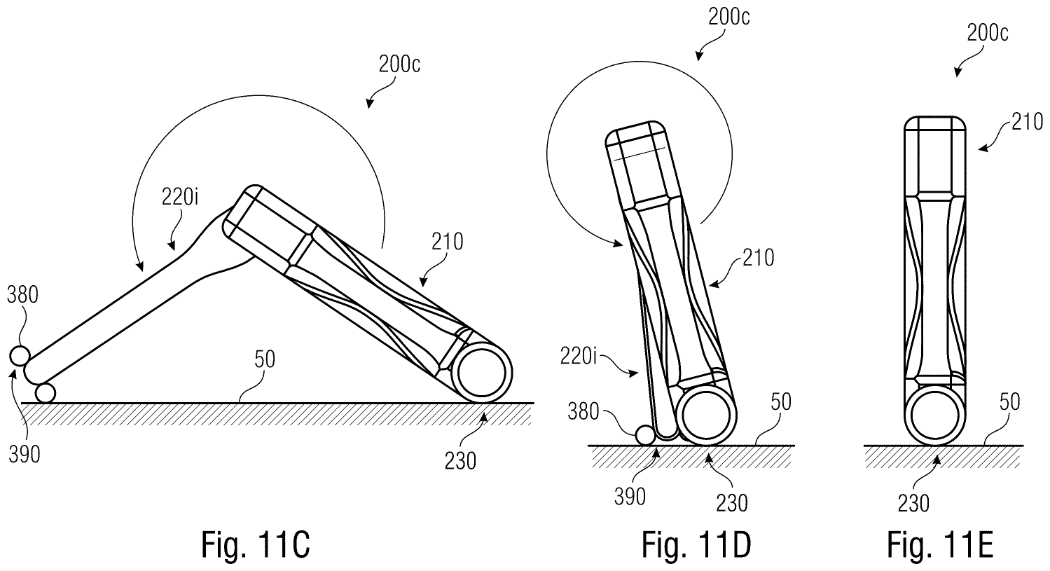

FIGS. 11a-e show schematic side views of an apparatus for transporting cargo with a support structure according to embodiments according to the first aspect of the present invention. FIGS. 11a-e show an apparatus 200c configured to comprise contact areas 230 for forming a contact with a ground 50. The apparatus 200c can be configured to provide the contact along exactly one axis of contact areas 230 at least during a transport trip for transporting the cargo (not shown), as is described, for example, in connection with an inverted pendulum described herein, see, for example, FIG. 2.

As an additional optional feature, the apparatus 200c comprises a support structure. The support structure can, for example, be arranged on the mobile platform 210 or can, for example, be arranged on pick-up means of the apparatus. In general, the support structure can be any structure that is configured to at least temporarily establish contact with the ground 50. Accordingly, simple elements such as an additional leg with a low-friction ground contact area or wheels can be used.

In the particularly advantageous configuration of FIGS. 11a-e, the pick-up means 220i comprises the support structure 390. The support structure can accordingly be arranged on one arm or two arms of the pick-up unit. Accordingly, the support structure 390 can be arranged on the pick-up means 220i away from the axis or can form the contact with the ground away from the vehicle axis, which can, for example, turn a 2-point system into a more stable 3-point system. It should be noted that such an arrangement is merely optional.

The apparatus 220c comprises control means configured to control the pick-up means 220i, starting from a first operating mode in which the contact areas 230 and the support structure 390 are in contact with the ground, to control the pick-up means for lifting the cargo and to switch to a second operating mode in which the support structure 390 is lifted from the ground. In other words, if needed, for example in a parking position or with a particularly large or unstable cargo on the one hand, or when driving empty without load on the other hand, an additional support structure can be used to obtain additional stability. This also makes it possible, for example, to temporarily reduce the energy consumption of the apparatus by using the control and/or actuator system only partially or not at all.

In the configuration of the apparatus 200c, the support structure 390 comprises wheels 380 as an optional feature, wherein the wheels can be formed, for example, as omnidirectional wheels and/or as omniwheels (e.g. small omniwheels) and/or as mecanum wheels. It should be mentioned again that the support structure can also be configured as a simple friction contact area (e.g. with a low coefficient of friction).

The steps of switching from the first operating mode to the second operating mode as well as self-righting of the apparatus, for example after an intentional or unintentional fall or lying down, are shown in FIGS. 11a-e. Self-righting is discussed first. As shown in FIG. a), the apparatus 200c can be configured to control the pick-up means 220i from a lying position into a rotational movement, which is shown in FIG. 11b and FIG. 11c at different times. This movement can, when continued, be used to increasingly raise the apparatus from the lying position, see FIG. 11d-e. Starting from a first, supported operating mode of FIG. 11c or FIG. 11d, the apparatus 200c in the representation of FIG. 11e can assume an unstable equilibrium state in the second operating mode, in particular if the supports in the state of FIG. 11e do not contact the floor any more or at least only along the axis 240, so that the pendulum motion of an inverted pendulum is made possible.

According to embodiments, omniwheels can therefore be attached to the ends of the arms. This makes it possible to bring the vehicle, e.g. the apparatus 200c, into a stable resting position. In this case, the vehicle rests on the arms or the omniwheels (see e.g. a)—in simple terms, the vehicle can lie sideways and comprise rollers at the ends of the arms or at the head). As the actuator for the rotation of the arm is self-locking, the whole vehicle can be switched off and is in a stable position. This also makes it possible to drive in an inherently stable manner. In the stable position, there is no more potential energy in the system. This means that the vehicle can be stopped or switched off at any time without causing damage due to its proper movement. In simple terms, the apparatus can comprise small omniwheels for a driving mode without balancing or for standing up.

With regard to standing up by moving the arms of the apparatus 200c, e.g. according to FIG. 11, the vehicle can thus be transferred from a lying position to a standing position with the aid of the rollers, e.g. wheels 380. Here, the arm can rotate by one full rotation. In the last part of the raising movement, the upright position is to be regulated.

Accordingly, the first operating mode can be, for example, a driving mode for operation with different driving characteristics than in the second operating mode, for example in order to be able to drive through areas where people are present, as the stable driving position enables particularly fast braking maneuvers and a safe way of driving. Further, if the apparatus fails, there is no risk of it falling over in an uncontrolled manner, which could injure people.

In general terms, the inventors have recognized the advantages of the special design of the inventive apparatus, so that the vehicle dynamics can be used by means of the two operating modes.

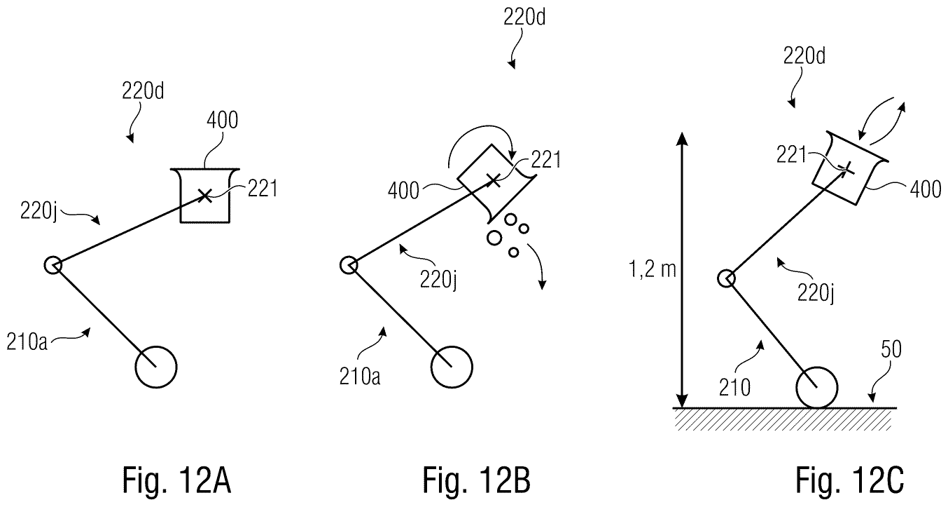

FIGS. 12a-c show schematic side views of an apparatus for transporting cargo with rotatable grippers 221 according to embodiments according to the first aspect of the present invention. The apparatus 200d (see, for example, FIG. 12a) comprises a mobile platform 210a, as well as pick-up means 220j, which comprises a rotatable gripper 221 as an optional feature, for example a rotatable contact element coupled to an exemplary open container 400. In this way, the cargo can be rotated over the rolling axis by means of rotatable gripper actuators (see FIG. 12b). This allows the cargo to be poured out, for example. As shown in FIG. 12c, a corresponding apparatus 200d can lift, for example, bulk material to a comparatively great height of up to or more than 1 m, 1.2 m or even 1.5 m.

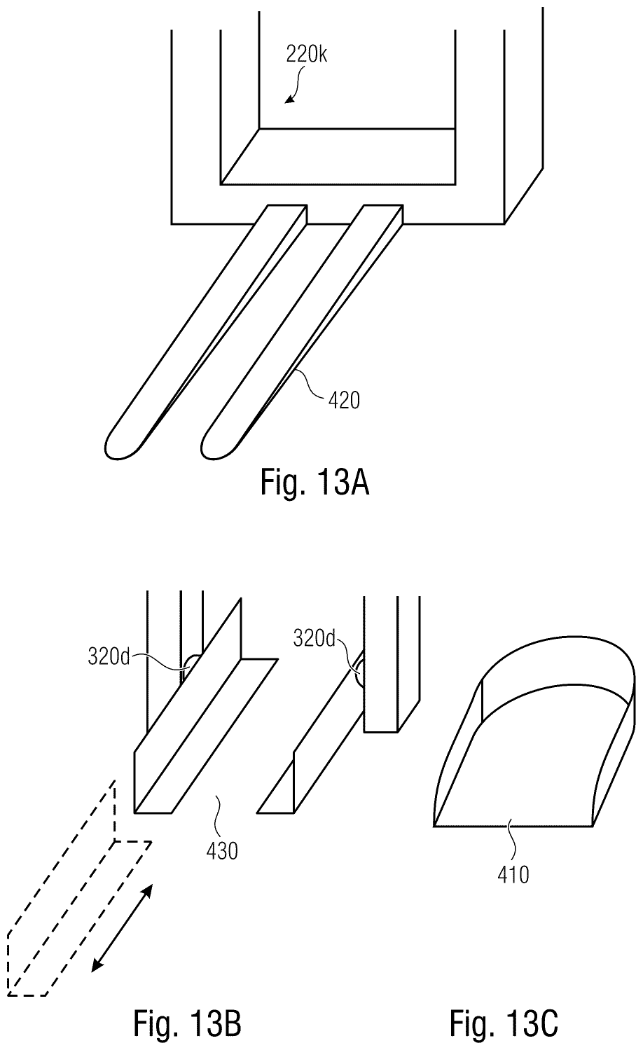

FIG. 13 shows schematic views of load transport tools according to embodiments according to the first aspect of the present invention. According to embodiments, an inventive apparatus can be configured to at least temporarily use a shovel 410, see FIG. 13c, or a fork 420, see FIG. 13a, as part of the pick-up means 220k to transport the cargo. Further, other transport tools, e.g. a fork set 430, see FIG. 13b, activated by means of contact elements 320d, can also be used.

In general, according to embodiments, any load transport tools, in particular forks 420 or shovels 410 (e.g. for various things, e.g. various bulk materials) can be used: By using a shovel between gripping actuators, for example between contact elements, (fork replacement 430 or replacement) it is possible to pick up bulk goods, transport them and unload them again by tilting the shovel. The transport goods can be inherently secured by the needed inclination of the vehicle during acceleration. By using lugged soft pneumatic tires, e.g. by using soft pneumatic tires with a profiled tread, it is possible to drive, e.g., on loose ground without any problems. The dynamic and automatic inclination of the cargo pick-up in dependence on the acceleration of the vehicle (see e.g. FIG. 5a-d) allows the discontinuous transport of bulk goods to be reliably automated. By using a fork 420, miniaturized pallets or, if the vehicle is scaled accordingly, europallets can be picked up and transported. The advantage of the vehicle concept comes into play here, particularly for stacked goods, as the same can also be transported at high accelerations without tipping over.

For example, apparatuses that can be fitted with forks can be configured to activate the forks themselves and, for example, pull them together. In addition, the arms of the apparatus can also be pulled together, for example, in order to pick up the fork 420 (e.g. by activating contact elements). For example, a fork can be used to pick up pallets. Further, the transport tools shown in FIG. 13, e.g. in particular tool 430, can be used to pick up cartons. In general, the apparatus can also comprise, for example, a drawer-like linear actuator, see, for example, possible movement in FIG. 13 b).

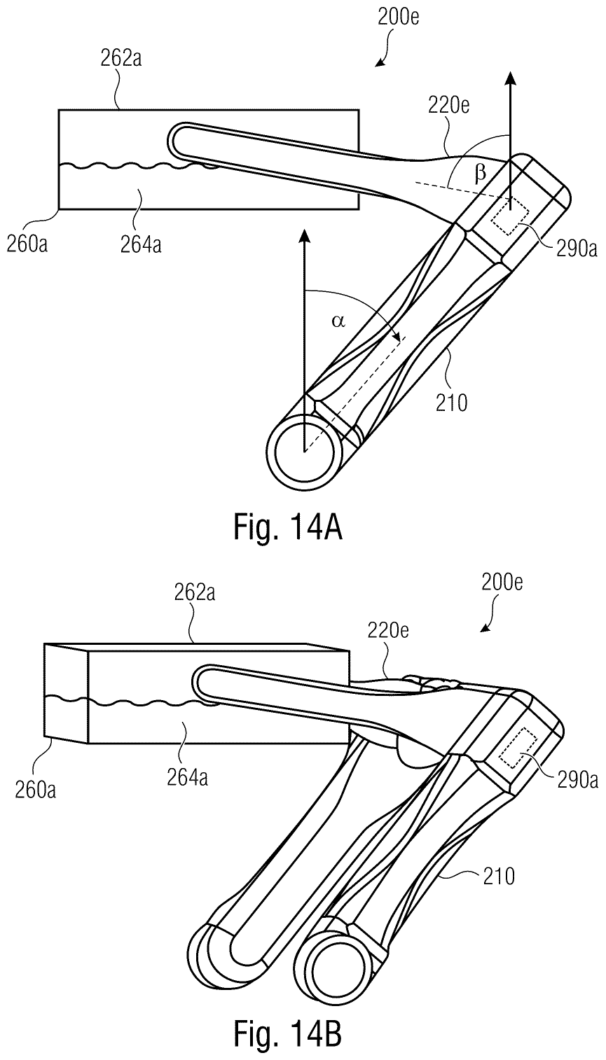

FIGS. 14a-b show a schematic side view and a schematic perspective view of an apparatus for transporting cargo comprising transport means and cargo arranged in the transport means, according to embodiments according to the first aspect of the present invention. FIGS. 14a-b show an apparatus 200e with a pick-up means 220l, configured to lift the cargo 260a including transport means 262a and cargo 260a arranged in the transport means. Further, the apparatus 200e is configured to move the cargo 260a with one movement. As an optional feature, the apparatus 200e comprises control means 290a, configured to keep an acceleration force of the cargo 264a, acting under the influence of the movement, relative to the transport means 260a within a tolerance range in a predefined orientation during the movement of the cargo 260a by providing a balancing movement.

Specifically, the cargo 264a can be, for example, a bulk material or a liquid, which is transported in an open container 262a. In order to prevent falling out or spilling or even sloshing around, the control means can cause balancing accelerations by means of a change in the inclination of the mobile platform 210 and a change in the inclination of the pick-up means 220l, i.e., for example, a change in the angles α and β. Optionally, actuated contact elements can also be controlled in order to achieve corresponding balancing accelerations.

This can prevent natural frequencies of liquids from impairing the driving characteristics, e.g. a safety-relevant braking distance, or cargo 264a from falling out of the container 262a. The apparatus 200e thus enables high accelerations and complex driving dynamics even with difficult cargo goods 262a.

Optionally, the balancing movement can comprise at least one of an inclination of the apparatus, e.g. by inclining a chassis or by causing pressure changes in tires of the apparatus, a rotation of the pick-up means, e.g. with respect to the platform, a tilting of the transport means by a rotational relative movement of two arms of the pick-up means with respect to each other, and/or tilting of the transport means by a rotational movement of an eccentrically mounted contact area on an arm of the pick-up means.

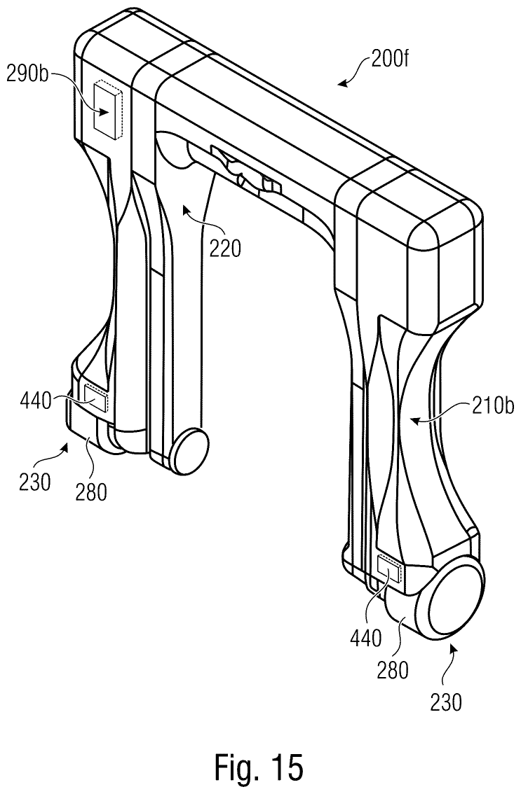

FIG. 15 shows a schematic view of an apparatus for transporting cargo with an actuator system for adapting a size of a contact area of a wheel according to embodiments according to the first aspect of the present invention. It should be noted that in FIG. 15 not all optional elements, e.g. according to FIG. 2 or the previously described pick-up means, are marked for improved clarity, but the same can be present individually or in combination.

FIG. 15 shows an apparatus 200f with a mobile platform 210b configured as an inverted pendulum, the platform 210 comprising a set 280 of wheels (e.g. a first and second set, 280a, 280b according to apparatus 200) for movement on a ground. As an optional feature, e.g. in addition to the features and functionalities according to apparatus 200, the apparatus 200f comprises an actuator system 440 connected to the set 280 of wheels for adapting a size of a contact area 230 of a wheel of the set of wheels with the ground. To this end, the apparatus 200f further comprises control means 290b (e.g. the control means 290 can include the functionality of the control means 290b) for controlling the actuator system 440, wherein the control means is configured to change the size of the contact area 230 of the wheel by means of the actuator system in dependence on at least one of a driving speed of the apparatus, a change of a direction vector of the apparatus and/or a ground condition.

Thus, for example, in an unstable resting position, for example in which the apparatus 200f is upright, a contact area 230 of the set 280 of wheels can be increased, for example as shown in FIG. 15, in order to save energy, since the increased area can reduce the regulation and actuator system effort and thus the energy requirement. Conversely, a contact area can be reduced during a movement in order to reduce the rolling resistance of the wheels. At the same time, a corresponding control can also be used, for example, to temporarily increase the contact area and therefore the traction control during cornering or a braking maneuver, for example to reduce the braking distance or to be able to take a tighter curve or increase the speed in the curve. A bend can also be taken advantageously with reduced area, for example if a drift is intended.

In some configurations, these statements relate to a symmetrical (for example with regard to left/right) control or adaptation of the contact areas. However, embodiments also provide, in combination or alternatively, for the contact areas to be adapted asymmetrically, for example by different pressures in different wheels, which can also generate a tilting or inclination of the vehicle, which has advantages when cornering, for example.

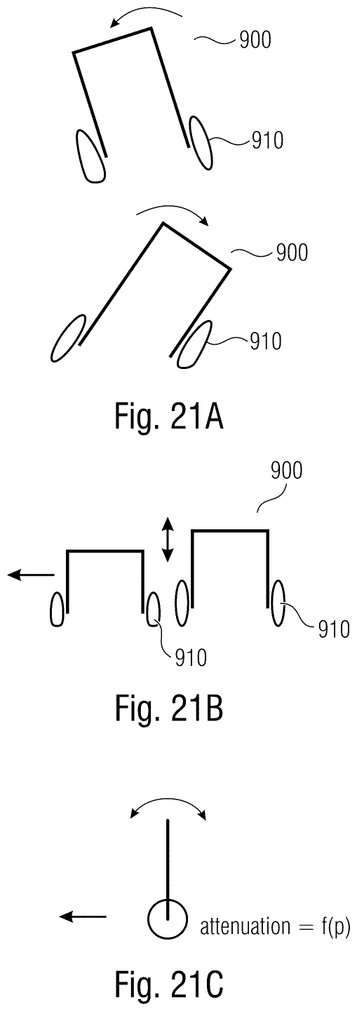

Both a symmetrical and an asymmetrical control can be controlled quasi-statically, for example depending on a longer section of the drive or load condition, but also dynamically, for example to counteract bumps and, for example, to keep the cargo at rest or to avoid rocking, as will be explained in detail in FIGS. 21a-c.

In general terms, the control means 290b can optionally be configured to set a first size of the contact area 230 by means of the actuator system 440 at a first movement speed and to set a second size of the contact area that is larger than the first size at a second movement speed that is lower than the first movement speed.

An optional way to change the size of the contact area is to adapt a gas pressure of gas-filled wheels or tires of the apparatus 200f by means of the actuator system, which can therefore provide compressed air, for example (wherein the actuator system can also provide a compressed air supply for bellows, for example—or vice versa). Depending on the application, any gas can be used as filling medium or filling gas, wherein air can already be suitable, but a closed circuit can also be arranged, for example, which uses a different gas, such as inert gases or a special gas composition, for example in the area of aggressive media. The pressure can be changed, for example, via a control by the control means 290b. Alternatively or in addition to changing a filling pressure, a contact surface can be changed, for example, by means of actuatable individual elements, such as blades, spikes or the like.

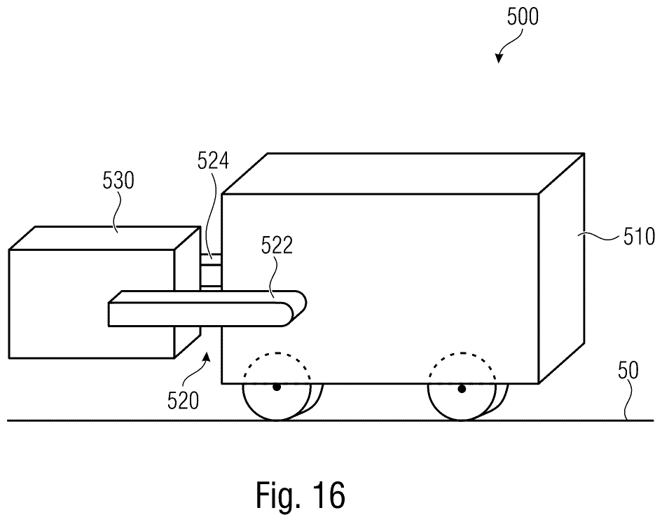

FIG. 16 shows a schematic view of an apparatus for transporting cargo according to embodiments according to the second aspect of the present invention. The apparatus 500 includes a mobile platform 510 and pick-up means 520 arranged on the mobile platform 510, which comprises at least two arms 522, 524 and is configured to lift the cargo 530 using the two arms by picking up the cargo between the two arms.

By lifting between the two arms, for example, no special requirements are placed on the cargo 530, for example with the exception of sufficient mechanical stability. Thus, for example, no special geometries are needed to establish a form fit, but a plurality of cargo goods 530 can be lifted, for example, with a force fit and/or friction fit.

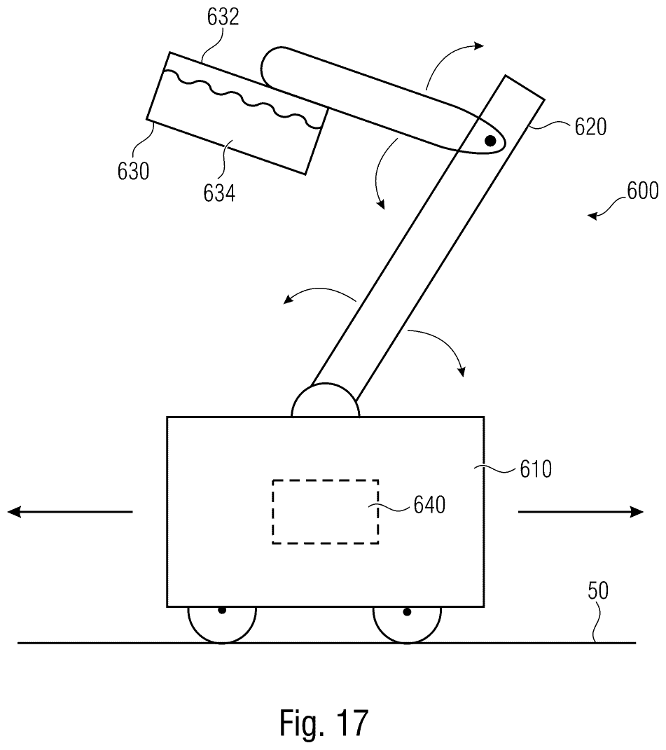

FIG. 17 shows a schematic view of an apparatus for transporting cargo according to embodiments according to the third aspect of the present invention. FIG. 17 shows the apparatus 600 including a mobile platform 610 and pick-up means 620 arranged movably on the mobile platform, which is configured to lift the cargo 630 including transport means 632 and cargo arranged in the transport means632. The apparatus 600 is configured to move the cargo 630 with one movement. Further, the apparatus comprises control means 640 configured to keep an acceleration force of the cargo 364, acting under the influence of the movement, relative to the transport means 632 within a tolerance range in a predefined orientation during the movement of the cargo by providing a balancing movement.

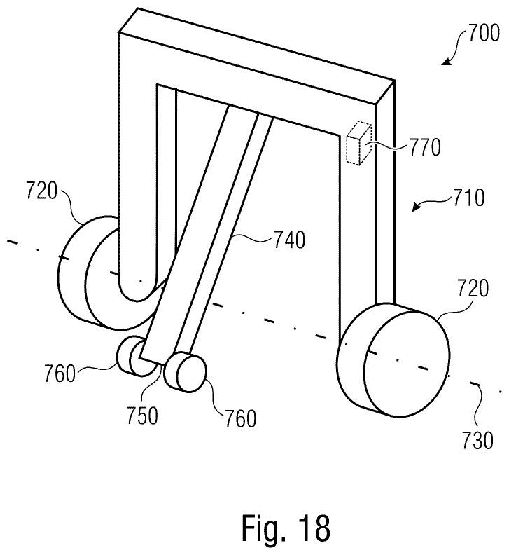

FIG. 18 shows a schematic view of an apparatus for transporting cargo according to embodiments according to the fourth aspect of the present invention. FIG. 18 shows an apparatus 700 including a mobile platform 710, wherein the mobile platform comprises a set of wheels 720 on an axis 730 for moving on a ground. Further, the apparatus 700 comprises pick-up means 740 arranged on the mobile platform 710, wherein a support structure 750 is arranged on the pick-up means for contact with the ground away from the axis. As an optional feature, the set of wheels 720 is a first set of wheels; and the support structure 750 comprises a second set of wheels 760 and wherein the second set of wheels is in contact with the ground in a first operating mode.

Further, the apparatus 700 comprises control means 770, which is configured to control the pick-up means 740 starting from the first operating mode, in which the set of wheels 720 and the support structure 750 (here as an optional feature the wheels 760) are in contact with the ground, to lift the cargo and to switch to a second operating mode, in which the support structure 750 is lifted from the ground. Alternatively or additionally, the set of wheels 760 or the support structure could also be moved to a position along the axis 730, wherein the movement of an inverted pendulum is also possible.

FIGS. 19a-b show schematic views of an apparatus for transporting cargo according to embodiments according to the fifth aspect of the present invention. FIG. 19 shows an apparatus 800 with a mobile platform 810, wherein the mobile platform comprises a set of wheels 820 for movement on a ground 50. Further, the apparatus 800 comprises an actuator system 840 connected to the set of wheels for adapting a size of a contact area 230a, 230b of a wheel of the set of wheels with the ground. Further, the apparatus comprises a control means 850 for controlling the actuator system 840, wherein the control means is configured to change the size of the contact area of the wheel by means of the actuator system in dependence on a driving speed of the apparatus, a change of a direction vector of the apparatus or in dependence on a ground condition.

As an example, starting from the situation shown in FIG. 19a, the control means 850 can control the actuator system 840 to reduce the contact area 230a so that a larger contact area 230b with the ground 50 results, see FIG. 19b.

As a further optional feature, the control means 850 can be configured to set a first size of the contact area 230a by means of the actuator system 840 at a first movement speed; and to set a second size 230b of the contact area that is larger than the first size at a second movement speed that is lower than the first movement speed.

As a further optional feature, the control means 850 can be configured to adapt a pressure of a filling medium or filling gas, e.g. an air pressure of the wheel, by means of the actuator system 840 in order to change the size of the contact area.

As a further optional feature, the apparatus 800 can be configured to transport cargo 260 and the control means 850 can be configured to change the size of the contact area 230a, 230b of the wheel by means of the actuator system 840 depending on a loading condition of the apparatus. The functions can be implemented in whole or in part in accordance with the embodiments of the first aspect, for example of FIG. 15.

As a further optional feature, the apparatus comprises a pick-up means 830 arranged on the mobile platform 810. Further, the apparatus 800 can be configured to lift the cargo 260 by means of the pick-up means 830 and to transport the lifted cargo.

In general, apparatuses according to the present invention can transport the cargo automatically or in a driverless manner or in an automated manner. In other words, the apparatuses described above can be automated guided transport vehicles.

In embodiments, the apparatus 800 can comprise two or more axes of wheels, but can alternatively be embodied as an inverted pendulum according to the first aspect.

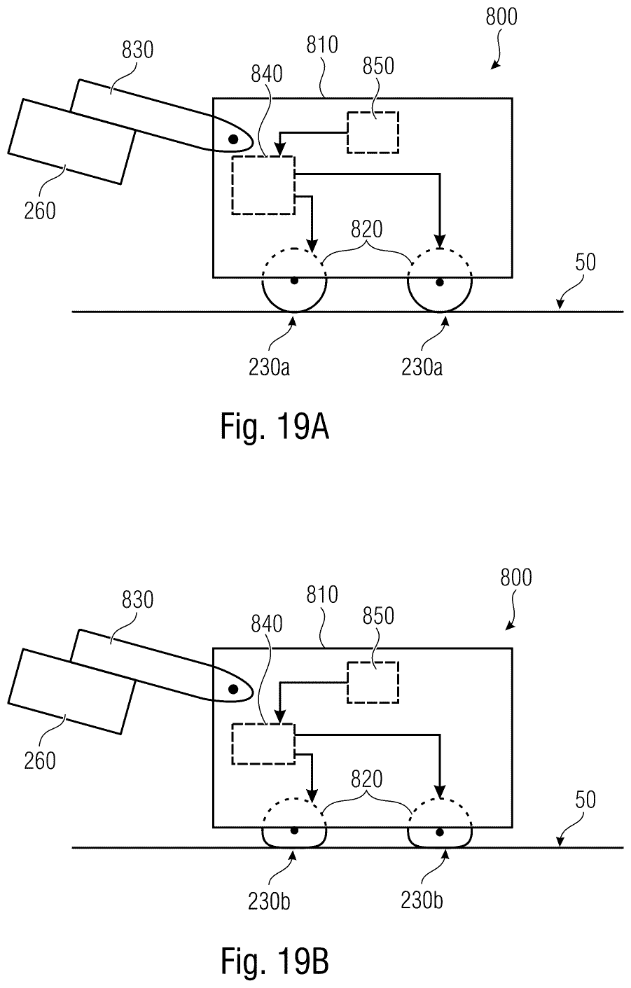

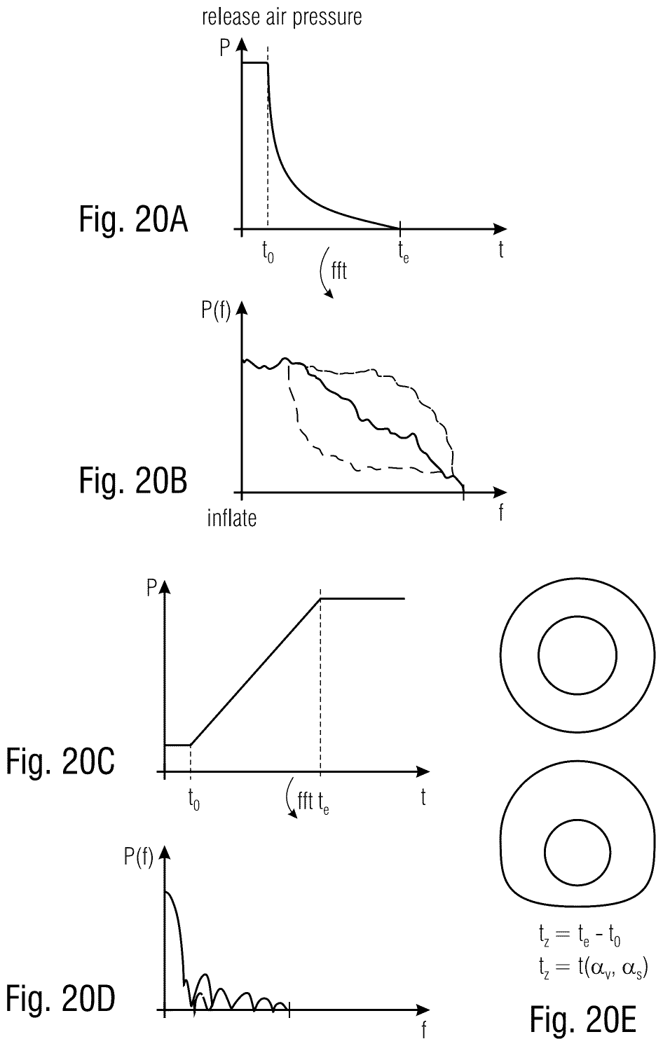

FIGS. 20a-d show plots according to embodiments including an actuator system for adapting a contact area of a wheel. FIG. 20a and FIG. 20b show plots when releasing gas pressure from a tire (e.g. when releasing a filling medium or filling gas), e.g. when releasing air pressure from a tire to change the contact area, on the one hand of the gas pressure, e.g. air pressure P over the time t in FIG. 20a and, on the other hand, of an associated Fourier transform P (f) (e.g. by means of FFT-fast Fourier transformation, in FIG. 20b over the frequency f). In FIG. 20c and FIG. 20d, corresponding plots are shown when a corresponding wheel is inflated. FIG. 20e shows an example of a wheel before releasing the gas pressure, e.g. air pressure, at the top, and after releasing the gas pressure, e.g. air pressure, at the bottom.

It should be noted that both the rolling resistance of a wheel and a spring constant of a wheel can exhibit a dependence on the pressure. Accordingly, an inventive actuator system can be used for the relationship rolling resistance=f (p) and spring constant=f (p).

The frequency that can be generated by active deflation and inflation can depend on the gas volume, e.g. air volume in the system (or tire) and the gas flow that can be generated, e.g. air flow. Basically, embodiments can operate, for example, according to two ways in which an actively induced change in gas pressure, e.g. air pressure, can be effected:
A) By quickly and actively changing the air pressure, vibration damping can be generated by destructively superimposing the existing and generated vibrations. There can be physical limits to the principle, e.g. vibrations up to a certain frequency can be usefully balanced. Such a frequency can, for example, be determined by at least one of a volume, e.g. a gas volume of the gas in the tire, a cross-section, e.g. a cross-section of the tire and/or a cross-section of a gas line for deflating or inflating the tire, and/or a maximum flow velocity, e.g. a flow velocity of the gas determined by the actuator system and supply lines. These can, for example, form constructive parameters of an apparatus according to the invention. Here, the frequency can be influenced by the actuator system and its dynamics, wherein, for example, a frequency of 0.25 Hz, 0.5 Hz, 1 Hz or higher, e.g. 2 Hz or 5 Hz, can be easily possible with pneumatic systems, but higher frequencies are nevertheless not excluded.
B) By changing the gas pressure, e.g. air pressure, the natural frequency of the system (vehicle) can be changed. This allows the pressure in the tire to be changed more or less quickly (but not, for example, with an actively counteracting frequency) in order to prevent disturbing vibrations.

Reference is made to FIG. 21a-c. FIGS. 21a-c show schematic views of dynamic states of an apparatus according to embodiments with an actuator system for adapting a contact area of a wheel. FIG. 21a shows a wavering apparatus 900 with wheels 910. According to embodiments, the vehicle dynamics can be actively interfered with by changing the contact area of the wheels with the ground. For example, by adjusting the gas pressure, e.g. air pressure, of the wheels, vibration damping can be achieved by destructive superimposition of vibrations. As shown in FIG. 20b-c, when inflating or deflating gas, e.g. air, frequencies can be introduced which can stabilize the vehicle while driving through destructive interference. A feasibility limit can be defined by the gas volume, e.g. air volume of the wheels, and the possible gas flow, e.g. air flow through the actuator system. In addition to waving vibrations as shown in FIG. 21a, vertical vibrations can also be reduced in this way.

Further, as shown in FIG. 21c, a passive improvement in vehicle dynamics can also be achieved. For example, a natural frequency of the apparatus can be changed by changing the air pressure. The damping of the wheels can be a function of the pressure (f (p)) so that, for example, damping properties can be configured. No continuous pressure change is needed for such an adaptation, for example.

In general, embodiments enable the following:
Comparatively low mechanical complexity with high regulation complexity to achieve, for example, the needed functionality (in particular high lift into a shelf)
Inherently vertically oriented acceleration from the perspective of the vehicle's inertial system. This prevents the cargo goods from tipping or spilling.

Advantages of embodiments compared to other solutions in the field of intralogistics are a high degree of flexibility combined with low mechanical complexity.

In general, embodiments can be used in the following technical areas of application:
General intralogistics: Automated transport of small cargo carriers such as containers, trays or cartons.
   Cases with a plurality of sources and/or sinks are particularly advantageous here; otherwise the multiple stationary installation of standardized transfer apparatuses for existing automated guided vehicles (with only simple load pick-up means such as Leo Locative or Weasel) would be associated with higher costs
   Production disposal, from many machines or workstations to the shipping area or warehouse (e.g. machine disposal in an injection molding plant)
   Production supply: Transport of e.g. assembly materials from the warehouse to the assembly line, especially shelf loading
   Provision of tools or material on the person. The vehicle acts as a third hand for the user. It is conceivable to enrich a “tray” with suitable tools or material. Both the angle and height can be adjusted. These parameters can be individually trained by the user by pressing the robot into the appropriate position. The distance from the user can also be maintained automatically in this scenario. The position relative to the user can also be specified (to the right, 54 cm and 30 degrees from the shoulder).

Further, there are areas of application in all other areas in which containers or container-like goods (i.e. goods with at least 2 parallel outer sides) are transported and cooperation with other infrastructure-free automatic systems (SAM or FLIP from Fraunhofer IML) when putting down and picking up on the floor can be enabled.

All lists of materials, environmental influences, electrical properties and optical properties given herein are to be considered as being exemplary and not exhaustive.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine-readable carrier.

Other embodiments comprise the computer program for performing one of the methods described herein, wherein the computer program is stored on a machine-readable carrier.

In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

The apparatuses described herein may be implemented, for example, by using a hardware apparatus or by using a computer or by using a combination of a hardware apparatus and a computer.

The apparatuses described herein or any components of the apparatuses described herein may be implemented at least partly in hardware and/or software (computer program).

The methods described herein may be implemented, for example, by using a hardware apparatus or by using a computer or by using a combination of a hardware apparatus and a computer.

The methods described herein or any components of the methods described herein may be performed at least partly by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An apparatus for transporting cargo, the apparatus comprising:
a mobile platform formed as an inverted pendulum; and
a pick-up unit arranged on the mobile platform;
wherein the apparatus is configured to lift the cargo by means of the pick-up unit and to transport the lifted cargo.

2. The apparatus according to claim 1, wherein the apparatus is configured to comprise contact areas for forming a contact with a ground;
wherein the apparatus is configured to provide contact along exactly one axis of contact areas at least during a transport trip for transporting the cargo.

3. The apparatus according to claim 1, wherein the platform comprises two leg elements arranged substantially parallel to each other and spaced apart from each other in a floor region; and
wherein the apparatus is configured to position the cargo at least temporarily between the leg elements.

4. The apparatus according to claim 3, wherein the apparatus comprises a chassis with a set of wheels, wherein a first subset of the set of wheels is arranged on a first leg element; and
wherein a second subset of the set of wheels, which is disjoint from the first subset, is arranged on a second leg element, which is different from the first leg element.

5. The apparatus according to claim 1, wherein the apparatus comprises a control configured to balance the apparatus and the cargo using additional information, wherein the additional information comprises at least one of
a loading condition of the apparatus,
a speed of the apparatus,
an acceleration of the apparatus,
an inclination of the mobile platform,
an orientation of the pick-up unit relative to the mobile platform,
a relative movement of the pick-up unit relative to the mobile platform,
a relative movement of the cargo with respect to the mobile platform,
a weight of the cargo,
a center of gravity of the cargo,
a torque in an actuator of the apparatus,
information about the geometry of the cargo, and/or
information about the type of cargo.

6. The apparatus according to claim 5, wherein the apparatus comprises a sensor configured to detect the additional information and to provide a sensor signal based thereon; and
wherein the control is configured to balance the apparatus and the lifted cargo based on the sensor signal.

7. The apparatus according to claim 1, wherein the pick-up unit provides at least one further pendulum segment.

8. The apparatus according to claim 1, wherein the apparatus comprises a platform height relative to a traversed ground during a transport trip for transporting the cargo; and
wherein the apparatus is configured to raise the cargo to a height above the platform height during the transport trip.

9. The apparatus according to claim 1, wherein the apparatus is configured to align the mobile platform relative to a surface normal of a traversed ground along a first direction and along a driving direction or opposite thereto; and to align the pick-up unit relative to the surface normal opposite to the first direction.

10. The apparatus according to claim 1, wherein the pick-up unit comprises at least two arms and is configured to lift the cargo using the two arms by picking up the cargo between the two arms.

11. The apparatus according to claim 10, wherein the apparatus comprises a control;
wherein the control is configured to control a first arm and a second arm of the at least two arms independently of each other, and/or
wherein the control is configured to control the first arm and the second arm in dependence on each other.

12. The apparatus according to claim 10, wherein at least one of the at least two arms comprises a contact element, wherein the contact element comprises an elastic, in particular a viscoelastic material; and
wherein the contact element is configured to establish contact with the cargo and thereby adapt to a shape of the cargo in order to lift the cargo under the action of the elastic material.

13. The apparatus according to claim 10, wherein the pick-up unit comprises exactly two arms.

14. The apparatus according to claim 10, wherein the at least two arms comprise one contact element each; and
wherein the contact elements are configured to establish a frictional fit and/or a force fit with the cargo.

15. The apparatus according to claim 1, wherein the pick-up unit is configured to pick up the cargo between a first contact element for contacting the cargo and a second contact element for contacting the cargo;
wherein the first contact element and the second contact element are connected to an actuator and are rotatably mounted; and
wherein the apparatus is configured to control the actuator, during lifting and/or acceleration of the cargo, to rotate the first contact element and the second contact element to adjust an orientation of the cargo.

16. The apparatus according to claim 1, wherein the pick-up unit comprises bellows, wherein the bellows is configured to release the cargo in a first state, and
to adapt to a shape of the cargo in a second state in order to provide a form fit and/or a force fit with the cargo,
to lift the cargo.

17. The apparatus according to claim 16, wherein the bellows is a pneumatic bellows.

18. The apparatus according to claim 1, wherein the pick-up unit comprises two opposite contact elements, and
wherein the contact elements are configured to pick up the cargo between the contact elements; and
wherein the pick-up unit comprises an actuator coupled to the contact elements and is arranged to move the two contact elements towards each other.

19. The apparatus according to claim 18, wherein at least one contact element is coupled to the actuator via a lever, and
wherein the actuator is configured to move the at least one contact element towards the opposite contact element by means of the lever.

20. The apparatus according to claim 19, wherein the two contact elements are coupled to the actuator via a respective lever, and
wherein the one actuator is configured to move the two contact elements towards each other by means of the respective lever.

21. The apparatus according to claim 18, wherein the actuator comprises a linear actuator.

22. The apparatus according to claim 1, wherein the pick-up unit comprises two opposite contact elements configured to pick up the cargo by means of contacting the cargo, wherein at least one of the contact elements is configured to be moved in the direction of the cargo by means of an eccentric.

23. The apparatus according to claim 1, wherein the pick-up unit comprises two opposite contact elements configured to pick up the cargo by means of contacting the cargo, wherein at least one of the contact elements is configured to be moved in the direction of the cargo by means of a rotational movement.

24. The apparatus according to claim 1, wherein the pick-up unit comprises two opposite contact elements configured to pick up the cargo between the contact elements;
wherein the contact elements are mounted in a tiltable manner in order to adapt to an angle of inclination of a surface of the cargo.

25. The apparatus according to claim 24, wherein the contact elements are mounted eccentrically.

26. The apparatus according to claim 1, wherein the pick-up unit comprises at least one arm comprising a joint structure between a first arm element and a second arm element; and
wherein the apparatus is configured to change a relative inclination of the first arm element and the second arm element by means of the joint structure for picking up or putting down the cargo.

27. The apparatus according to claim 1, wherein the apparatus is configured to comprise contact areas for establishing contact with a ground; and
wherein the apparatus is configured to provide the contact along exactly one axis of contact areas at least during a transport trip for transporting the cargo; and
wherein the apparatus comprises a support structure for contact with the ground; and
wherein the apparatus comprises a control configured to control the pick-up unit to lift the cargo, starting from a first operating mode in which the contact areas and the support structure are in contact with the ground, and to switch to a second operating mode in which the support structure is lifted from the ground; or is arranged along the exactly one axis.

28. The apparatus according to claim 27, wherein the support structure is arranged away from the axis on the pick-up unit.

29. The apparatus according to claim 27, wherein the support structure comprises an omniwheel and/or an omnidirectional wheel and/or a mecanum wheel.

30. The apparatus according to claim 27, wherein the apparatus is configured to assume an unstable equilibrium state in the second operating mode.

31. The apparatus according to claim 1, wherein the apparatus is configured to control the pick-up unit into a rotational movement from a lying position in order to thereby raise the apparatus from the lying position.

32. The apparatus according to claim 1, wherein the apparatus is configured to at least temporarily use a shovel or a fork as part of the pick-up unit to transport the cargo.

33. The apparatus according to claim 1, wherein the pick-up unit is configured to lift the cargo comprising a transport unit and cargo arranged in the transport unit; and
wherein the apparatus is configured to move the cargo with one movement; and
wherein the apparatus comprises a control configured to keep an acceleration force of the cargo, acting under the influence of the movement, relative to the transport unit within a tolerance range in a predefined orientation during the movement of the cargo by providing a balancing movement.

34. The apparatus according to claim 33, wherein the balancing movement comprises at least one of:
an inclination of the apparatus, for example by inclining a chassis or by causing pressure changes in the tires of the apparatus,
a rotation of the pick-up unit, for example with respect to the platform,
a tilting of the transport unit by a rotational relative movement of two arms of the pick-up unit with respect to each other, and/or
a tilting of the transport unit by a rotational movement of an eccentrically mounted contact area on an arm of the pick-up unit.

35. The apparatus according to claim 1, wherein the mobile platform comprises a set of wheels for movement on a ground;
wherein the apparatus comprises an actuator system connected to the set of wheels for adapting a size of a contact area of a wheel of the set of wheels with the ground; and
wherein the apparatus comprises a control for controlling the actuator system, wherein the control is configured to change the size of the contact area of the wheel by means of the actuator system in dependence on at least one of
a driving speed of the apparatus,
a change of a direction vector of the apparatus
properties of the ground and/or
a ground condition.

36. The apparatus according to claim 35, wherein the control is configured to set a first size of the contact area by means of the actuator system at a first movement speed and to set a second size of the contact area that is larger than the first size at a second movement speed that is lower than the first movement speed.

37. The apparatus according to claim 35, wherein the control is configured to adapt an air pressure of the wheel by means of the actuator system to change the size of the contact area.

38. An apparatus for transporting cargo, the apparatus comprising:
a mobile platform; and
a pick-up unit arranged on the mobile platform, which comprises at least two arms and is configured to lift the cargo using the two arms by picking up the cargo between the two arms.

39. An apparatus for transporting cargo, the apparatus comprising:
a mobile platform; and
a pick-up unit movably arranged on the mobile platform, configured to lift the cargo comprising the transport unit and cargo arranged in the transport unit; and
a control;
wherein the apparatus is configured to move the cargo with one movement; and
wherein the control is configured to keep an acceleration force of the cargo, acting under the influence of the movement, relative to the transport unit within a tolerance range in a predefined orientation during the movement of the cargo by providing a balancing movement.

40. An apparatus for transporting cargo, the apparatus comprising:
a mobile platform, the mobile platform comprising a set of wheels on an axis for movement on a ground; and
a pick-up unit arranged on the mobile platform, wherein a support structure for contact with the ground is arranged on the pick-up unit; and
a control configured to control the pick-up unit to lift the cargo, starting from a first operating mode in which the set of wheels and the support structure are in contact with the ground, and to switch to a second operating mode in which the support structure is lifted from the ground; or is arranged along an axis of wheels from which the support structure is positioned away in the first operating mode.

41. The apparatus according to claim 40, wherein the set of wheels is a first set of wheels; wherein the support structure comprises a second set of wheels, and wherein the second set of wheels is in contact with the ground in the first operating mode.

42. The apparatus, comprising:
a mobile platform, the mobile platform comprising a set of wheels for movement on a ground; and
an actuator system connected to the set of wheels for adapting a size of a contact area of a wheel of the set of wheels with the ground; and
a control for controlling the actuator system, wherein the control is configured to change the size of the contact area of the wheel by means of the actuator system in dependence on a driving speed of the apparatus, a change of a direction vector of the apparatus, of properties of the ground, or in dependence on a ground condition.

43. The apparatus according to claim 42, wherein the control is configured to set a first size of the contact area by means of the actuator system at a first movement speed; and to set a second size of the contact area that is larger than the first size at a second movement speed that is lower than the first movement speed.

44. The apparatus according to claim 42, wherein the control is configured to adapt an air pressure of the wheel by means of the actuator system to change the size of the contact area.

45. The apparatus according to claim 42, wherein the apparatus is configured to transport cargo; and wherein the control is configured to change the size of the contact area of the wheel by means of the actuator system in dependence on a loading state of the apparatus.

46. The apparatus according to claim 45, comprising
a pick-up unit arranged on the mobile platform;
wherein the apparatus is configured to lift the cargo by means of the pick-up unit and is configured to transport the lifted cargo.

47. The apparatus according to claim 1, wherein the apparatus is an automated guided transport vehicle.

48. The apparatus according to claim 38,
wherein the mobile platform is configured as an inverted pendulum.

49. A method for transporting cargo, comprising:
lifting the cargo by means of pick-up unit, wherein the pick-up unit is arranged on a mobile platform and wherein the mobile platform is configured as an inverted pendulum; and
transporting the lifted cargo.

50. A method for transporting cargo, comprising:
picking up the cargo between at least two arms of a pick-up unit, wherein the pick-up unit is arranged on a mobile platform; and
lifting the cargo using the two arms.

51. A method for transporting cargo, comprising:
lifting the cargo by means of a pick-up unit movably arranged on a mobile platform, wherein the cargo comprises a transport unit and cargo arranged in the transport unit; and
moving the cargo with one movement; and
providing a balancing movement, by means of a control, during the movement of the cargo, in order to keep an acceleration force of the cargo, acting under the influence of the movement, relative to the transport unit within a tolerance range in a predefined orientation.

52. A method for transporting cargo, comprising:
controlling a pick-up unit for lifting the cargo, starting from a first operating mode in which a set of wheels and a support structure are in contact with a ground, to switch to a second operating mode in which the support structure is lifted from the ground;
wherein the pick-up unit is arranged on a mobile platform and wherein the support structure for contact with the ground is arranged on the pick-up unit; and
wherein the mobile platform comprises the set of wheels on one axis for movement on a ground.

53. A method, comprising:
controlling an actuator system by means of a control to change the size of a contact area of a wheel of a set of wheels by means of the actuator system in dependence on a driving speed of a mobile platform, a change of a direction vector of the mobile platform or in dependence on a ground condition,
wherein the mobile platform comprises the set of wheels for movement on the ground; and
wherein the actuator system for adapting the size of the contact area of the wheel of the set of wheels with the ground is connected to the set of wheels.
